(19) United States
(12) Patent Application Publication
(10) Pub. No.: US 2026/0040377 A1
(43) Pub. Date: Feb. 5, 2026

(54) ELECTRONIC DEVICE FOR DETERMINING BLUETOOTH COMMUNICATION TIME, AND OPERATION METHOD THEREFOR

(71) Applicant: Samsung Electronics Co., Ltd., Suwon-si (KR)

(72) Inventors: Gupil CHEONG, Suwon-si (KR); Doosuk KANG, Suwon-si (KR); Hyungseoung YOO, Suwon-si (KR); Heejae YOON, Suwon-si (KR); Juyeon JIN, Suwon-si (KR)

(21) Appl. No.: 19/351,854

(22) Filed: Oct. 7, 2025

Related U.S. Application Data
(63) Continuation of application No. PCT/KR2024/003106, filed on Mar. 11, 2024.

(30) Foreign Application Priority Data
Apr. 20, 2023 (KR) 10-2023-0051872
Apr. 25, 2023 (KR) 10-2023-0054274

(51) Int. Cl. H04W 76/14; H04R 3/12; H04W 4/80

(52) U.S. Cl. CPC H04W 76/14; H04R 3/12; H04W 4/80

(57) ABSTRACT

A first electronic device is provided. The first electronic device includes communication circuitry, a memory storing instructions, and at least one processor communicatively coupled to the communication circuitry and the memory, wherein the instructions, when executed by the at least one processor individually or collectively, cause the first electronic device to establish a communication link with a second electronic device through the communication circuit, determine first information related to a first time in which the first electronic device receives first audio data of an audio service from a source electronic device, acquire second information related to a second time at which the second electronic device receives second audio data of the audio service from the source electronic device, based on the first time and the second time, determine a third time for the communication link, and communicate with the second electronic device through the communication link by using the third time.

### CROSS-REFERENCE TO RELATED APPLICATION(S)

This application is a continuation application, claiming priority under 35 U.S.C. § 365 (c), of an International application No. PCT/KR2024/003106, filed on Mar. 11, 2024, which is based on and claims the benefit of a Korean patent application number 10-2023-0051872, filed on Apr. 20, 2023, in the Korean Intellectual Property Office, and of a Korean patent application number 10-2023-0054274, filed on Apr. 25, 2023, in the Korean Intellectual Property Office, the disclosure of each of which is incorporated by reference herein in its entirety.

### BACKGROUND

### 1. Field

The disclosure relates to an electronic device for determining a Bluetooth communication time and an operation method thereof.

### 2. Description of Related Art

Bluetooth communication technology may provide a short-range wireless communication technology that enables electronic devices to be connected to each other for exchanging data or information. Bluetooth communication technology may include Bluetooth legacy (or classic) communication technology or Bluetooth low energy (BLE) communication technology and include various topologies, such as piconet or scatternet.

Recently in wide use are electronic devices adopting Bluetooth communication technology. In particular, a pair of earbuds that may be respectively worn on both ears of the user are widely used as an ear-wearable device. An ear-wearable device may provide various functions. For example, an ear-wearable device may include a microphone to identify the user's voice, thereby transmitting data of the user's voice to an electronic device (e.g., a smartphone). Furthermore, the ear-wearable device may include a speaker to output the audio data received from an electronic device (e.g., a smartphone) to through the speaker.

The ear-wearable device may include a primary earbud (e.g., the right earbud) and a secondary earbud (e.g., the left earbud) that may be connected to an electronic device (e.g., a smartphone). The primary earbud may transmit voice data to the electronic device through connection with the electronic device, and the electronic device may transmit audio data (or audio content) to the primary earbud. The primary earbud may transfer audio data (or audio content) received from the electronic device through wireless communication to the secondary earbud and may output the audio data through the speaker. The secondary earbud may be synchronized with the primary earbud and may output the audio data transferred from the primary earbud or electronic device through the speaker.

The primary earbud and the secondary earbud (hereinafter referred to as “earbuds”) may be connected to the electronic device based on Bluetooth communication to perform the above operations. To this end, the earbuds may perform a pairing operation including an inquiry and/or an inquiry scan operation, or a BLE advertising and/or BLE scan operation.

The BLE advertising operation may indicate an operation for periodically broadcasting an advertising packet through an advertising physical channel, and the BLE scan may indicate an operation for monitoring reception of the advertising packet.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide, an electronic device and an operation method thereof receiving audio data transmitted from a source electronic device.

Another aspect of the disclosure is to provide an electronic device and an operation method thereof may negotiate and change a time for communication with an external electronic device for receiving an audio service.

Additional aspects will be set forth in part in the description which follows and, in part, will be apparent from the description, or may be learned by practice of the presented embodiments.

In accordance with an aspect of the disclosure, a first electronic device is provided. The first electronic device includes communication circuitry, memory storing instructions, and at least one processor communicatively coupled to the communication circuitry and the memory, wherein the instructions, when executed by the at least one processor individually or collectively, cause the first electronic device to establish a communication link with a second electronic device through the communication circuitry, determine first information related to a first time in which the first electronic device receives first audio data of an audio service from a source electronic device acquire second information related to a second time in which the second electronic device receives second audio data of the audio service from the source electronic device, based on the first time and the second time, determine a third time for the communication link, and communicate with the second electronic device through the communication link by using the third time.

In accordance with another aspect of the disclosure, an electronic device is provided. The electronic device includes a wireless communication module, memory storing instructions, and at least one processor communicatively coupled to the memory and the wireless communication module, wherein the instructions, when executed by the at least one processor individually or collectively, cause the electronic device to establish at least one communication link with at least one external electronic device through the wireless communication module, determine a first time in which the at least one external electronic device receives an audio service from a source electronic device, determine whether the first time conflicts with a second time in which the electronic device communicates with the at least one external electronic device, in case that the first time conflicts with the second time, determine operating information indicating a third time configured for the at least one communication link so as not to overlap at least partially with the first time, and transmit the operating information to the at least one external electronic device through the wireless communication module.

In accordance with another aspect of the disclosure, A method of operating a first electronic device is provided. The method includes establishing a communication link with a second electronic device, determining first information related to a first time in which the first electronic device receives first audio data of an audio service from a source electronic device, acquiring second information related to a second time in which the second electronic device receives second audio data of the audio service from the source electronic device, determining, based on the first time and the second time, a third time for the communication link, and communicating with the second electronic device through the communication link by using the third time

In accordance with another aspect of the disclosure, A method of operating an electronic device is provided. The method includes establishing at least one communication link with at least one external electronic device, determining a first time in which the at least one external electronic device receives an audio service from a source electronic device, determining whether the first time conflicts with a second time in which the electronic device communicates with the at least one external electronic device, in case that the first time conflicts with the second time, determining operating information indicating a third time configured for the at least one communication link so as not to overlap at least partially with the first time, and transmitting the operating information to the at least one external electronic device

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include establishing a first communication link with a second electronic device, determining first information related to a first time in which the first electronic device receives first audio data of an audio service from a source electronic device, acquiring second information related to a second time in which the second electronic device receives second audio data of the audio service from the source electronic device, based on the first time and the second time, determining a third time for the communication link, and communicating with the second electronic device through the communication link by using the third time.

In accordance with another aspect of the disclosure, a non-transitory computer-readable storage medium configured to store one or more programs is provided. The one or more programs includes instructions configured to, when executed by at least one processor of an electronic device, cause the electronic device to establish at least one communication link with at least one external electronic device, determine a first time in which the at least one external electronic device receives an audio service from a source electronic device, determine whether the first time conflicts with a second time in which the electronic device and the at least one external electronic device communicate, in case that the first time conflicts with the second time, determine operating information indicating a third time configured for the at least one communication link so as not to overlap at least partially with the first time, and transmit the operating information to the at least one external electronic device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 illustrates a connection between electronic devices based on short-distance wireless communication according to an embodiment of the disclosure;

FIG. 3 illustrates a configuration of an electronic device supporting short-distance wireless communication according to an embodiment of the disclosure;

FIG. 4 illustrates a Bluetooth low energy (BLE) scan operation according to an embodiment of the disclosure;

FIG. 5 is a sequence diagram illustrating an example of an operation procedure for connected isochronous stream (CIS) establishment according to an embodiment of the disclosure;

FIG. 6 illustrates an example of CIS parameters configured for CIS communication according to an embodiment of the disclosure;

FIG. 7 is a time diagram illustrating an example of CIS communication according to an embodiment of the disclosure;

FIG. 8 illustrates an example of a CIS event according to an embodiment of the disclosure;

FIGS. 9 and 10 illustrate examples of CIS transmission according to various embodiments of the disclosure;

FIG. 11 illustrates a sequence diagram illustrating a procedure of synchronization with a broadcast isochronous group (BIG) according to an embodiment of the disclosure;

FIG. 12 illustrates BIG parameters according to an embodiment of the disclosure;

FIG. 13 illustrates a BIG event and a BIS event according to an embodiment of the disclosure;

FIGS. 14, 15, and 16 illustrate retransmission of BIS data packets according to various embodiments of the disclosure;

FIG. 17 illustrates a time for Bluetooth communication according to an embodiment of the disclosure;

FIG. 18 illustrates reallocation times for bridge communication and an audio service according to an embodiment.

FIG. 19 is a flowchart illustrating an operation of adjusting a time for bridge communication to avoid a conflict with audio communication according to an embodiment of the disclosure;

FIG. 20 illustrates topology of a CIS audio service according to an embodiment of the disclosure;

FIG. 21 is a sequence diagram illustrating an operation of negotiating a bridge communication time in consideration of a CIS audio service according to an embodiment of the disclosure;

FIG. 22 illustrates a procedure of avoiding a conflict during a CIS operation according to an embodiment of the disclosure;

FIG. 23 is a flowchart illustrating a procedure of adjusting a bridge communication time in consideration of a CIS audio service according to an embodiment of the disclosure;

FIG. 24 illustrates topology for a BIS audio service according to an embodiment of the disclosure;

FIG. 25 illustrates topology for an assistant-based BIS audio service according to an embodiment of the disclosure;

FIG. 26 is a sequence diagram illustrating an operation of negotiating a bridge communication time in consideration of a BIS audio service according to an embodiment of the disclosure;

FIG. 27 illustrates a procedure of avoiding a conflict during a BIS operation according to an embodiment.

FIG. 28 is a flowchart illustrating a procedure of adjusting a bridge communication time in consideration of a BIS audio service according to an embodiment of the disclosure;

FIGS. 29 and 30 illustrate establishment of CIS links according to various embodiments of the disclosure;

FIG. 31 illustrates generation of a CIS link according to an embodiment of the disclosure;

FIG. 32 illustrates time periods of a CIS link according to an embodiment of the disclosure;

FIG. 33 illustrates an operation of applying a new time in consideration of an audio communication time according to an embodiment of the disclosure;

FIG. 34 is a sequence diagram illustrating bridge communication in consideration of a BIS reception time according to an embodiment of the disclosure;

FIG. 35 illustrates time periods of a BIG according to an embodiment of the disclosure;

FIG. 36 illustrates an example of changing operation information of a second communication link and a third communication link according to an embodiment of the disclosure;

FIG. 37 illustrates an example of determining a conflict of BIS audio according to an embodiment of the disclosure;

FIG. 38 illustrates an example of avoiding a conflict of BIS audio according to an embodiment of the disclosure; and

FIG. 39 is a flowchart illustrating a procedure of changing a communication time in consideration of a BIS audio service according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

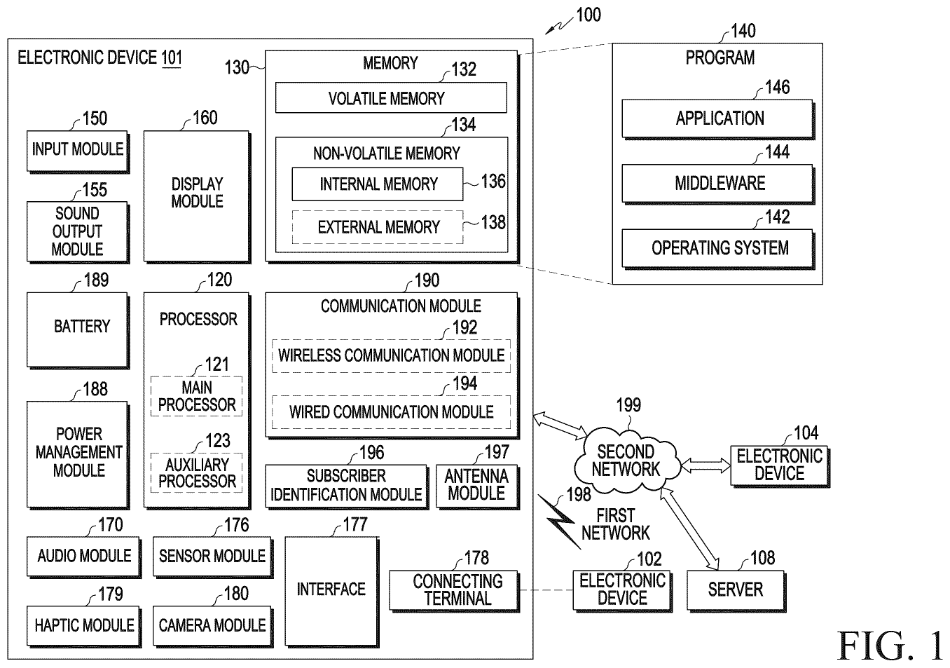

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (cMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per seconds (Gbps) or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

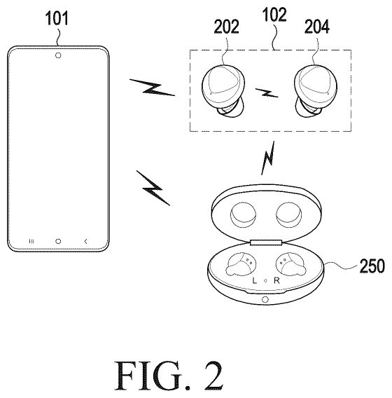

FIG. 2 illustrates a connection between electronic devices based on short-distance wireless communication according to an embodiment of the disclosure.

Referring to FIG. 2, an external electronic device 102 (e.g., an ear-wearable device) may be wirelessly connected to an electronic device (e.g., an electronic device 101). In an embodiment, the electronic device 101 may be a smartphone, a tablet PC, or a notebook computer. In an embodiment, the external electronic device 102 may be a true wireless stereo (TWS) device such as a binaural ear-wearable device, and may include at least one of a first external electronic device 202 (e.g., a left earbud) and a second external electronic device 204 (e.g., a right earbud).

In an embodiment, the first electronic device 202 and the second electronic device 204 are illustrated as a pair of earbuds, but the first electronic device 202 and the second electronic device 204 may include not only earbuds but also all devices which can operate as a pair. According to an embodiment, the first electronic device 202 and the second electronic device 204 may be implemented as elements equal or similar to each other.

According to an embodiment, the electronic device 101 may configure a connection (e.g., a communication link) with a least one of the first electronic device 202 or the second electronic device 204, and may transmit and/or receive data to/from each other. For example, the electronic device 101 may configure, based on a short-distance wireless communication technology such as at least one of a Wi-Fi scheme, a Bluetooth scheme (e.g., Bluetooth classic or Bluetooth low energy (BLE)), or an ultra-wideband (UWB) scheme, a communication link with at least one of the first electronic device 202 and the second electronic device 204, but the scheme in which the electronic device 101 configures the communication link with the first electronic device 202 and the second electronic device 204 is not limited to at least one of the Wi-Fi scheme, the Bluetooth scheme, or the UWB scheme.

In an embodiment, the electronic device 101 may configure a communication link with only one of the first electronic device 202 and the second electronic device 204, or may configure individual communication links with the first electronic device 202 and the second electronic device 204, respectively.

In an embodiment, the electronic device 101 may operate as a central (or master) device, or a primary (or main) device, and the external electronic device 102 (e.g., at least one of the first electronic device 202 or the second electronic device 204) may operate as a peripheral (or slave or secondary) device. The electronic device 101 operating as a central device may transmit data to the external electronic device 102 (e.g., the first electronic device 202 or the second electronic device 204) operating as a peripheral device. For example, when the electronic device 101 and the first electronic device 202 configure a communication link with each other, the electronic device 101 is selected as a central device, and the first electronic device 202 may be selected as a peripheral device. In a case of an audio service, the electronic device 101 operating as a central device may be a source electronic device, and the electronic device (e.g., the first electronic device 202 or the second electronic device 204) operating as a peripheral device may be a sink electronic device.

In an embodiment, the first electronic device 202 and the second electronic device 204 may configure, based on at least one of the Wi-Fi scheme, the Bluetooth scheme, or the UWB scheme, a communication link with each other, but the scheme in which the first electronic device 202 and the second electronic device 204 configure a communication link is not limited to at least one of the Wi-Fi scheme, the Bluetooth scheme, or the UWB scheme.

In an embodiment, one of the first electronic device 202 and the second electronic device 204 may operate as a central (or primary) device, and the other may operate as a peripheral (or secondary) device. An electronic device (e.g., the first electronic device 202) operating as a central device may transmit data (e.g., a reception identification signal or relay data) to an electronic device (e.g., the second electronic device 204) operating as a peripheral device. For example, when the first electronic device 202 and the second electronic device 204 configure a communication link with each other, one of the first electronic device 202 and the second electronic device 204 may be randomly selected as a central device, and the other may be selected as a peripheral device.

The first electronic device 202 and the second electronic device 204 may directly or indirectly communicate with an external electronic device 250. In an embodiment, the external electronic device 250 may be an ear bud case device or a cradle device for storing and charging the first electronic device 202 and the second electronic device 204.

According to an embodiment, the external electronic device 250 may configure a connection (e.g., a communication link) with at least one of the electronic device 101, the first electronic device 202, or the second electronic device 204, and transmit and/or receive data to/from each other. For example, the external electronic device 250 may configure, based on a Wi-Fi scheme, a Bluetooth scheme (e.g., Bluetooth classic or Bluetooth low energy (BLE)), or a UWB scheme, a communication link with at least one of the electronic device 101, the first electronic device 202, or the second electronic device 204, but the scheme in which the external electronic device 250 configures a communication link with the electronic device 101, the first electronic device 202, or the second electronic device 204 is not limited to at least one of the Wi-Fi scheme, the Bluetooth scheme, or the UWB scheme.

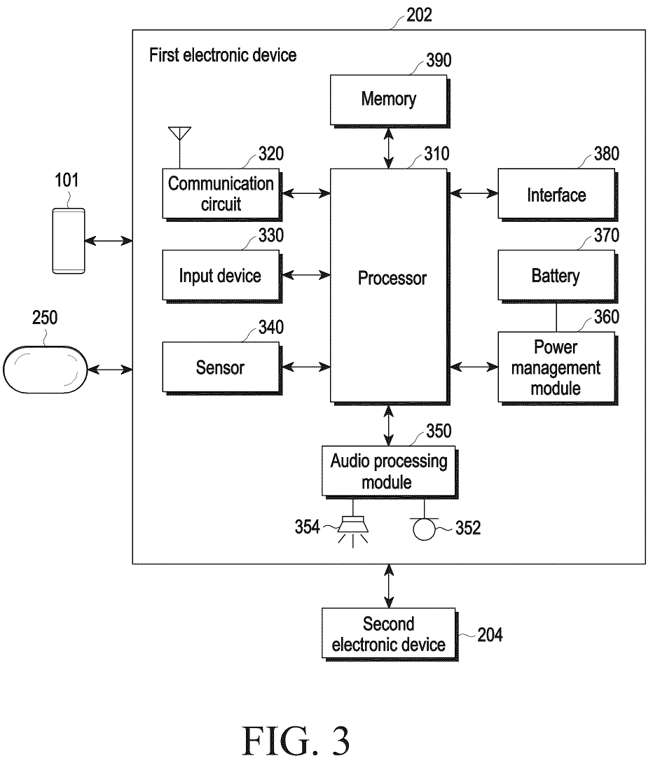

FIG. 3 illustrates a configuration of an external electronic device supporting short-distance wireless communication according to an embodiment of the disclosure.

Referring to FIG. 3, the electronic device 101 may be wirelessly connected to the electronic devices 202 and 204. The electronic device 101 may be implemented as, for example, a smartphone, but is not limited to those described and/or shown, and may be implemented as various types of devices (e.g., a notebook computer including a standard laptop computer, an ultrabook, and a tabbook, a laptop computer, a tablet computer, or a desktop computer). The electronic device 101 may be implemented as shown in FIG. 1, and may thus include at least some of the elements (e.g., various modules) shown in FIG. 1, and a duplicate description thereof is thus omitted below.

The electronic devices 202 and 204 may be implemented as wireless earbuds, but are not limited to those described and/or shown, and may be implemented as various types of devices (e.g., a smart watch, a head-mounted display device, and devices for measuring biometric signals (e.g., heartrate patch)) that supports an audio service as described below. According to an embodiment, when the electronic devices 202 and 204 are wireless earbuds, the first electronic device 202 and the second electronic device 204 may be a pair of devices (e.g., a left earbud and a right earbud). According to an embodiment, the first external electronic device 202 and the second external electronic device 204 may be implemented to include the identical or similar elements to each other.

According to an embodiment, the electronic device 101 may establish a communication connection with at least one of the electronic devices 202 and 204 and transmit and/or receive data to/from each other. For example, each of the electronic devices 202 and 204 may configure a communication connection with the electronic device 101 by using device-to-device (D2D) communication, such as Wi-Fi Direct or Bluetooth (e.g., using a communication circuit (e.g., the communication circuit 320) supporting the corresponding communication scheme, but is not limited thereto, and may communicate with each other using other various types of communication (e.g., a communication scheme such as Wi-Fi, using access points (APs), a cellular communication scheme using base stations, or a wired communication scheme).

In an embodiment, one of the first electronic device 202 and the second electronic device 204 may be a primary device (or a master device or a main device), the other device may be a secondary device (or a slave device or a sub device), and the primary device (or the main device) may transmit data to the secondary device. For example, when the first electronic device 202 and the second electronic device 204 configure a communication connection with each other, any one of the first electronic device 202 and the second external electronic device 204 may be randomly selected as the primary device, and the other may be selected as the secondary device. In an embodiment, when the first electronic device 202 and the second electronic device 204 configure a communication connection with each other, the device detected as first worn on a human body (e.g., when a value indicating wearing is detected by a wearing detection sensor (e.g., a proximity sensor, a touch sensor, a slope 6-axis sensor, or a 9-axis sensor)) may be selected as the primary device, and the other may be selected as the secondary device.

In an embodiment, the primary device may transmit data received from the electronic device 101 to the secondary device. For example, the first electronic device 202 corresponding to the primary device may not only output, based on audio data received from the electronic device 101, audio to a speaker 354 but also transmit the audio data to the second electronic device 204 corresponding to the secondary device. In an embodiment, the second electronic device 204 corresponding to the secondary device may receive, based on connection information provided from the primary device (e.g., the first electronic device 202), audio data transmitted from the electronic device 101 to the primary device (e.g., the first electronic device 202), through snipping.

In an embodiment, the first electronic device 202 corresponding to the primary device may transmit, to the electronic device 101, data (e.g., audio data or response data) received from the second electronic device 204 corresponding to the secondary device. For example, when a touch event occurs in the second electronic device 204 corresponding to the secondary device, control data including information on the occurring touch event may be transmitted to the electronic device 101 by the first electronic device 202 corresponding to the primary device. However, the disclosure is not limited to those described above, as described above, the secondary device (e.g., the second electronic device 204) and the electronic device 101 may configure a communication connection with each other, and accordingly, transmission and/or reception of data between the secondary device and the electronic device 101 may be directly performed.

In an embodiment, the first electronic device 202 may include the identical or similar elements to at least one of the elements (e.g., modules) of the electronic device 101 illustrated in FIG. 1. The first electronic device 202 may include a processor 310 (e.g., the processor 120 of FIG. 1), a communication circuit 320 (e.g., the communication module 190 of FIG. 1), an input device 330 (e.g., the input module 150 of FIG. 1), a sensor 340 (e.g., the sensor module 176 of FIG. 1), an audio processing module 350 (e.g., the audio module 170 of FIG. 1), a power management module 360 (e.g., the power management module 188 of FIG. 1), a battery 370 (e.g., the battery 189 of FIG. 1), an interface 380 (e.g., the interface 177 of FIG. 1), and memory 390 (e.g., the memory 130 of FIG. 1).

According to an embodiment, the communication circuit 320 may include at least one of a wireless communication module (e.g., a Bluetooth communication module, a cellular communication module, a wireless-fidelity (Wi-Fi) communication module, a near-field communication (NFC) communication module, or a global navigation satellite system (GNSS) communication module) or a wired communication module (e.g., a local area network (LAN) communication module or a power line communication (PLC) communication module). As an example, the Bluetooth communication module may support at least one communication connection (e.g., communication link) by Bluetooth legacy communication (e.g., Bluetooth classic) and/or Bluetooth low energy (BLE) communication.

The communication circuit 320 may directly or indirectly communicate with at least one of the electronic device 101 (e.g., a smartphone), the external electronic device 250 (e.g., a charging device such as a cradle), or the second electronic device 204 (e.g., the secondary earbud) through a first network (e.g., the first network 198 of FIG. 1) by using at least one communication module. The second electronic device 204 may be configured in pair with the first electronic device 202. The communication circuit 320 may include a transmission circuit and a reception circuit configured to support communication with the electronic device 101 and/or the external electronic device 250. The communication circuit 320 may include one or more communication processors that are operable independently from the processor 310 and support wired or wireless communication.

According to an embodiment, the communication circuit 320 may be connected with one or more antennas capable of transmitting signals or information to another electronic device (e.g., the electronic device 101, the second electronic device 204, or the external electronic device 250 (e.g., a cradle device)) or receiving signals or information from the other electronic device. According to an embodiment, at least one antenna appropriate for a communication scheme used in a communication network such as the first network (e.g., the first network 198 of FIG. 1) or the second network (e.g., the second network 199 of FIG. 2) may be selected from the plurality of antennas by for example, the communication circuit 320. The signal or information may be transmitted or received between the communication circuit 320 and another electronic device via the selected at least one antenna.

According to an embodiment, the input device 330 may be configured to generate various input signals that may be used for operation of the first electronic device 202. The input device 330 may include at least one of a touch pad, a touch panel, or a button.

According to an embodiment, the input device 330 may generate a user input for the turn-on/off of the first electronic device 202. According to an embodiment, the input device 330 may receive a user input for a communication connection between the first electronic device 202 and the second electronic device 204. According to an embodiment, the input device 330 may receive a user input associated with audio data (or audio content). For example, the user input may be associated with functions of starting playback of audio data, pausing playback, stopping playback, adjusting playback speed, adjusting playback volume, or muting.

According to an embodiment, the sensor 340 may measure or identify the position or operational state of the first electronic device 202. The sensor 340 may convert measured or identified information into an electric signal. The sensor 340 may include at least one of, for example, a magnetic sensor, an acceleration sensor, a gyro sensor, a geomagnetic sensor, a proximity sensor, a gesture sensor, a grip sensor, a biometric sensor, or an optical sensor.

According to an embodiment, the processor 310 may detect data (e.g., audio data) from data packet (e.g., protocol datagram units (PDUs) received from the electronic device 101 and may process the detected data through the audio processing module 350 and output the same to the speaker 354. The audio processing module 350 may support an audio data gathering function and play the gathered audio data.

According to an embodiment, the audio processing module 350 may include an audio decoder (not shown) and a D/A converter (not shown). The audio decoder may convert audio data stored in the memory 390 or received from the electronic device 101 through the communication circuit 320 into a digital audio signal. The D/A converter may convert the digital audio signal converted by the audio decoder into an analog audio signal. According to an embodiment, the audio decoder may convert audio data received from the electronic device 101 through the communication circuit 320 and stored in the memory 390 into a digital audio signal. The speaker 354 may output the analog audio signal converted by the D/A converter.

According to an embodiment, the audio processing module 350 may include an A/D converter (not shown). The A/D converter may convert the analog audio signal transferred through the microphone 352 (hereinafter, referred to as a mic) into a digital voice signal. The mic 352 may include at least one air conduction microphone and/or at least one bone conduction microphone for detecting voice and/or sound.

According to an embodiment, the audio processing module 350 may play various audio data configured in the operation of the first electronic device 202. For example, the processor 310 may be designed to detect insertion or removal of the first electronic device 202 into or from the user's ear through the sensor 340 and play audio data relating to an effect sound or guide sound through the audio processing module 350. The output of the sound effect or guide sound may be omitted according to the user configuration or a designer's intention.

According to an embodiment, the memory 390 may store various data used by at least one element (e.g., the processor 310 or a sensor 340) of the first electronic device 202. The data may include, for example, software and input data or output data for a command related thereto. The memory 390 may include volatile memory or non-volatile memory.

According to an embodiment, the power management module 360 may manage power supplied to the first electronic device 202. According to an embodiment, the power management module 360 may be implemented as at least part of, for example, a power management integrated circuit (PMIC). According to an embodiment, the power management module 360 may include a battery charging module. According to an embodiment, if another electronic device (e.g., one of the electronic device 101, the second external electronic device 204, or another electronic device) is electrically connected with the first electronic device 202 (wirelessly or wiredly), the power management module 360 may receive power from the other electronic device to charge the battery 370.

According to an embodiment, the battery 370 may supply power to at least one element of the first electronic device 202. The battery 370 may include, for example, a rechargeable battery. According to an embodiment, if the first electronic device 202 is mounted in the cradle device (e.g., the external electronic device 250), the first electronic device 202 may charge the battery 370 to a designated charging level and then power on the first electronic device 202 or turn on at least a part of the communication circuit 320.

According to an embodiment, the interface 380 may support one or more designated protocols that may be used for the first electronic device 202 to directly (e.g., wiredly) connect to the electronic device 101, the second electronic device 204, the cradle device (e.g., the external electronic device 250), or another electronic device. The interface 380 may include at least one of, for example, a high definition multimedia interface (HDMI), a USB interface, an SD card interface, a power line communication (PLC) interface, or an audio interface. According to an embodiment, the interface 380 may include at least one connection port for establishing a physical connection with the cradle device (e.g., the external electronic device 250).

According to an embodiment, the processor 310 may execute software to control at least one other element (e.g., a hardware or software element) of the first electronic device 202 connected with the processor 310, and may perform various data processing or computations. According to an embodiment, as at least part of the data processing or computation, the processor 310 may load a command or data received from another element (e.g., the sensor 340 or communication circuit 320) onto volatile memory 390, process the command or the data stored in the volatile memory 390, and store resulting data in non-volatile memory.

According to an embodiment, the processor 310 may establish a communication connection with the electronic device 101 through the communication circuit 320 and receive data (e.g., audio data) from the electronic device 101 through the established communication connection. According to an embodiment, the processor 310 may transmit the data, received from the electronic device 101 through the communication circuit 320, to the second electronic device 204. According to an embodiment, the processor 310 may perform the operations of the first electronic device 202 which are to be described below. According to an embodiment, the processor 310 may include a physical layer, a link layer, a host, and an application layer for performing Bluetooth communication.

According to various embodiments, the first electronic device 202 may further include various modules depending on the form in which it is provided. There are many variations according to the convergence trend of digital devices, so it is not possible to list them all, but elements equivalent to the above-mentioned elements may be further included in the first electronic device 202. In addition, it is apparent that in the first electronic device 202 according to various embodiments, specific elements may be excluded from the above elements or replaced with other elements according to the form in which it is provided. This will be easily understood by those skilled in the art.

According to various embodiments, the second electronic device 204 configured in pair with the first electronic device 202 may include the same elements as those included in the first electronic device 202, and may perform all or some of the operations of the first electronic device 202 described below in connection with the drawings.

In an embodiment, the electronic device 101 may discover at least one of the electronic devices 202 and 204 through BLE scanning and establish a BLE connection with the discovered device. At least one of the external electronic devices 202 and 204 may perform BLE advertising to be discovered by the electronic device 101, and establish a BLE connection with the electronic device 101.

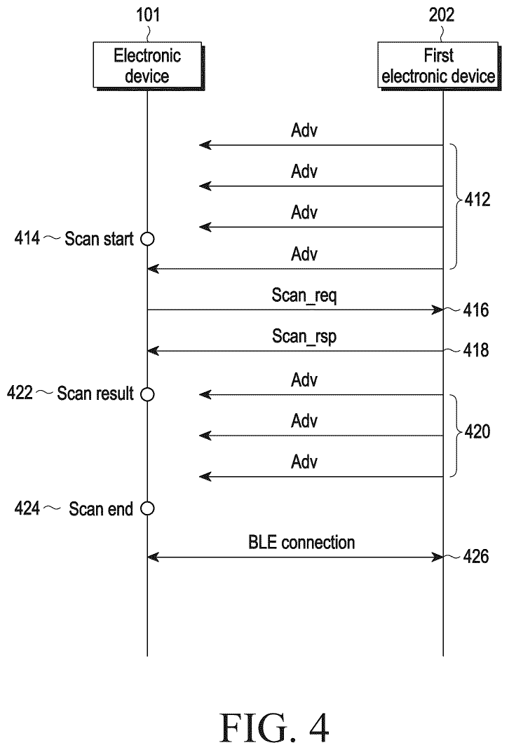

FIG. 4 illustrates a Bluetooth LE (BLE) scan operation according to an embodiment of the disclosure.

Referring to FIG. 4, according to operation 414, the electronic device 101 may start to perform a scan operation for discovering a nearby Bluetooth device based on BLE. In operation 412, the first electronic device 202 may periodically transmit (e.g., multicast or broadcast) an advertising packet (“ADV”) to be discovered by a nearby Bluetooth device based on BLE. In an embodiment, the advertising packet may include advertising data (e.g., periodic advertising PDU (PA) data), and the advertising data may provide information related to a connection or account (e.g., pairing) with the first electronic device 202 to an unspecified nearby electronic device (e.g., the electronic device 101). In an embodiment, the advertising packet may include at least one of identification information about the first electronic device 202, the user's account information, information about whether the first electronic device 202 is paired with another electronic device (not shown), a list of devices previously paired with the first electronic device 202, information about devices simultaneously pairable, transmission power, a detection area, or remaining battery power information.

In an embodiment, the first electronic device 202 may start the operation of transmitting an advertising packet in response to a user input for, e.g., a pairing request. In an embodiment, the first electronic device 202 may be stored in the cradle device (e.g., the third electronic device 250), and if the cradle device is opened while being stored in the cradle device or is removed from the cradle device, transmission of the advertising packet may be started. In an embodiment, the first electronic device 202 may transmit the advertising packet according to a designated condition. In an embodiment, the second electronic device 202 may start the transmission of the advertising packet based on at least one of when power is supplied or a designated time period.

In an embodiment, the electronic device 101 may receive at least one of the advertising packets broadcasted from the first electronic device 202 and output a user interface for connection with the first electronic device 202 on the display. The electronic device 101 may provide a user interface according to various conditions based on the information included in the received advertising packet. As an example, the user interface may include at least one of an image, a user account, transmission power, or remaining battery power corresponding to the first electronic device 202.

In operation 416, the electronic device 101 may transmit, to the first electronic device 202, a scan request packet (e.g., Scan_req) corresponding to the advertising packet received from the first electronic device 202. In operation 418, the first electronic device 202 may transmit a scan response packet (e.g., Scan_rsp) corresponding to the scan request packet to the electronic device 101. In an embodiment, even while or after the scan request packet of operation 416 and the scan response packet of operation 418 are exchanged, the first electronic device 202 may continuously and periodically transmit the advertising packet in operation 420.

In operation 422, the electronic device 101 may generate a scan result (including, for example, a received signal strength indicator (RSSI)) according to reception of the scan response packet. In an embodiment, the electronic device 101 may terminate the scan operation according to reception of the scan response packet in operation 424. Alternatively, the electronic device 101 may continue the scan operation. In operation 426, the electronic device 101 may establish a BLE-based communication link (e.g., asynchronous connection-less (ACL) link) with the first electronic device 202. In an embodiment, operation 426 may include transmission of a CONNECT_IND and the first data packet.

The BLE communication link may include a plurality of LE physical channels which may be optimized and used for their different purposes, for example, an LE piconet physical channel, an LE advertising physical channel, an advertising periodic physical channel, and an LE isochronous physical channel. The LE piconet physical channel may be used for communication between the connected devices and may be connected with a specific piconet. The LE advertising physical channel may be used to broadcast advertising (advertisements) to the Bluetooth device. The advertising may be used for discovery of user data, connection, or transmission of user data to the counterpart electronic device. The advertising periodical physical channel may be used to transmit user data to the counterpart electronic device at specific intervals through periodic advertising. The LE isochronous physical channel may be used to transfer isochronous data between Bluetooth devices in an LE piconet, or transfer isochronous data between unconnected Bluetooth devices.

An electronic device (e.g., the electronic device 101, the first electronic device 202, or the second electronic device 204) may support audio services through a connected isochronous stream (CIS) scheme and/or broadcast isochronous stream (BIS) based on a Bluetooth communication technology.

CIS may mean logical transport capable of transmitting isochronous data in any direction between electronic devices (e.g., the electronic device 101, the first electronic device 202, or the second electronic device 204). CIS may transfer data (e.g., CIS data packets) having a fixed or variable data size, and each CIS link may be associated with an ACL link. A CIS link may support transmission of variable size packets and one or more packets in each isochronous event, and support various data speeds. Data traffic on the CIS link may be unidirectional or bidirectional, and an acknowledgment (ACK) protocol may be used to enhance reliability of data transmission on the CIS link.

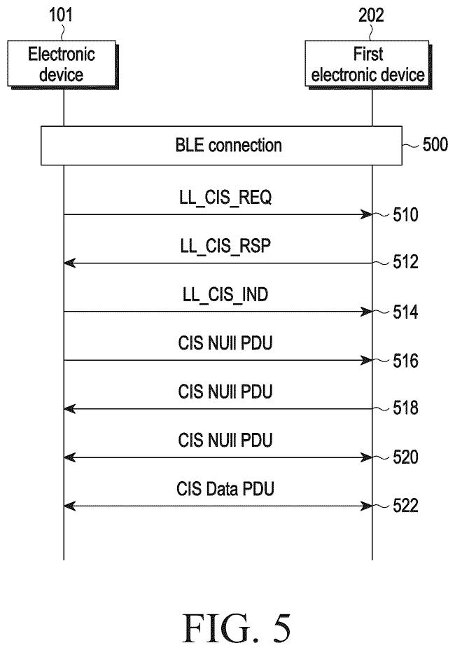

FIG. 5 is a sequence diagram illustrating an example of an operation procedure for CIS establishment according to an embodiment of the disclosure.

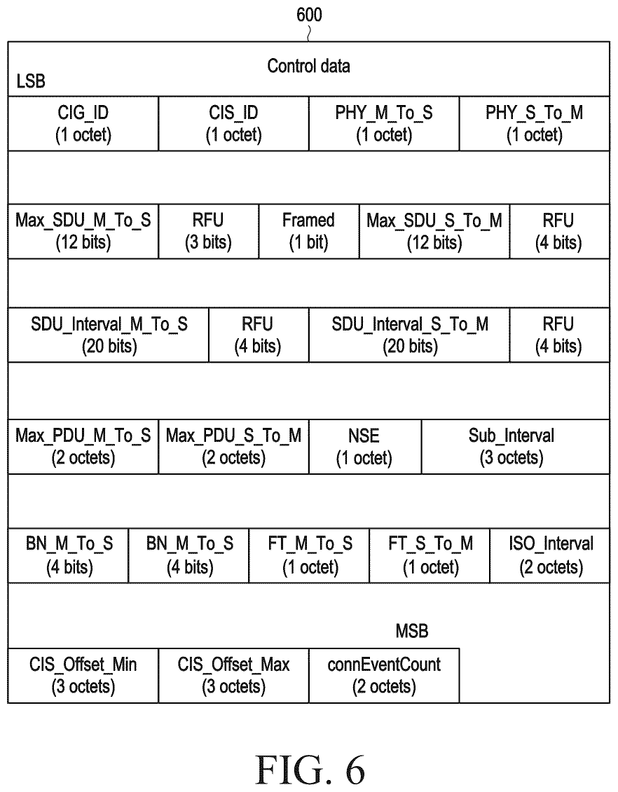

Referring to FIG. 5, in operation 500, an electronic device (e.g., a CIS source electronic device or the electronic device 101) may have a BLE connection (e.g., an ACL link or a second communication link 2012) with a counterpart electronic device (e.g., a CIS sink electronic device or the first electronic device 202). In operation 510, the electronic device 101 may transmit, to the first electronic device 202, a link layer CIS request message (e.g., LL_CIS_REQ packet) including CIS parameters (e.g., the control data 600 of FIG. 6) for defining a CIS link (e.g., a first CIS link 2022). In operation 512, the electronic device 101 may receive a link layer CIS response message (e.g., LL_CIS_RSP packet) from the first electronic device 202. In operation 514, the electronic device 101 may transmit a link layer CIS indication message (e.g., LL_CIS_IND packet) to the first electronic device 202.

In operations 516, 518, and 520, the electronic device 101 and the first electronic device 202 may establish a CIS link by exchanging one or more CIS null packets (e.g., protocol data units (PDUs)). In operation 522, the electronic device 101 and the first electronic device 202 may communicate CIS data PDUs through the CIS link.

In BLE, CIS may mean logical transmission enabling transmission of isochronous data in any direction between electronic devices that have created a communication link. The CIS is capable of transmitting data having a variable size as well as a fixed data size, and may be used for both framed data and unframed data. For each CIS, a schedule of time slots known as events and subevents may be configured. The CIS may be capable of adjusting a data rate by transmitting a variable size packet and one or more packets in each isochronous event. Data traffic on the CIS link may be transmitted unidirectionally or bidirectionally between devices and may include an acknowledgment (ACK) protocol to enhance reliability of packet transmission.

FIG. 6 illustrates an example of CIS parameters configured for CIS communication according to an embodiment of the disclosure.

Referring to FIG. 6, the parameters (referred to as, for example, CIS parameters) used for CIS communication may be provided to the counterpart electronic device (e.g., the first electronic device 202) through the control data 600 included in the LL_CIS_REQ of operation 510. In an embodiment, the electronic device 101 operating as a master role (or as a central device) may allocate CIS_ID for CIS communication, and the CIS_ID may be shared with the first electronic device 202 operating as a slave role (or as a peripheral device) through the link layer message (e.g., LL_CIS_REQ).

In an embodiment, the control data 600 may include at least one parameter among CIG_ID for identifying a CIS group (CIG) (e.g., CIG (510)), CIS_ID for identifying the CIS link (e.g., the first CIS link 2022), a parameter (including, for example, PHY_M_To_S and PHY_S_To_M) indicating a physical layer transmission scheme between a master and a slave (hereinafter, referred to as PHY), a Max_SDU parameter (including, for example, Max_SDU_M_To_S and Max_SDU_S_To_M) indicating the maximum size of a service data unit (SDU), at least one reserved for future use (RFU) field, a Framed field, an SDU_Interval parameter (SDU_Interval_M_to_S and SDU_Interval_S_to_M), a Max_PDU parameter (including, for example, Max_PDU_M_To_S and Max_PDU_S_To_M) indicating the maximum PDU size, a number of subevent (NSE), a Sub_Interval field, a burst number (BN) parameter (including, for example, BN_M_To_S and BN_S_To_M), a flushing time (FT) parameter (including, for example, FT_M_To_S and FT_S_To_M), an ISO_Interval, a CIS offset parameter (including, for example, CIS_Offset_Min and CIS_Offset_Max), or a connEventCount.

The parameters configured by the control data 600 may be applied to audio data transmission on the CIS link and may not be changed until the CIS link is terminated after the CIS link is created. The CIS_ID may be shared with the host of the first electronic device 202 via link layers of the electronic device 101 and the first electronic device 202 and may not be used in the link layer.

PHY_M_To_S and PHY_S_To_M may indicate a PHY used for data transmission in a master-to-slave direction and a PHY used for data transmission in a slave-to-master direction, respectively. On the CIS link, the PHYs (e.g., at least one of 1 mega-symbol per second (LE 1M), 2 mega-symbol per second (LE 2M), Coded PHY with S=2, or Coded PHY with S=8) indicated by PHY_M_To_S and PHY_S_To_M may be used.

The ISO_Interval may indicate a regular time interval between two contiguous CIS anchor points, and one CIS event may occur starting at each anchor point within one isochronous (ISO) interval. One CIS event may include one or more subevents indicating a master-to-slave transmission occasion. The Sub_Interval may indicate a time interval between two contiguous subevents within one CIS event, and the maximum length of each subevent may be designated by SE_Length. The Max_PDU may indicate the maximum size of the CIS data PDU. The Max_SDU may indicate the maximum size of the SDU on the CIS. The NSE may indicate a maximum number of subevents in each CIS event. The BN designated by the BN parameter may indicate the number of packets that can be transmitted without ACK/NACK. The NSE parameter may be the larger value of BN_M_To_S and BN_S_To_M and may be set up to 31. The FT parameter may indicate a maximum number of CIS events in which the CIS data PDU may be transmitted (or retransmitted), and may have a value from 1 to 255.

The same encryption of the ACL link is applicable to the encryption of the CIS link. Both the central device (e.g., the electronic device 101) and the peripheral device (e.g., the first electronic device 202) may have a 39-bit CIS event counter (cisEventCounter), and after setting the CIS event counter to 0 for the first CIS event of the CIS link, the CIS event counter may be incremented by 1 each time an isochronous PDU is transmitted in each CIS event. The CIS link may have a CIS payload number (cisPayloadNumber) of 39 bits, and when the CIS payload number is 239-1, the CIS link may be terminated. The CIS null PDU may not have cisPayloadNumber.

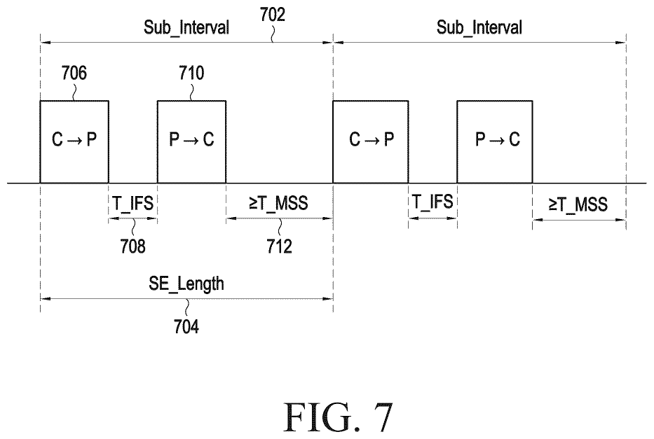

FIG. 7 is a time diagram illustrating an example of CIS communication according to an embodiment of the disclosure.

Referring to FIG. 7, CIS communication may include CIS events that occur at a designated interval (e.g., the ISO interval indicatable by the ISO_Interval), and each CIS event may include one or more subevents (e.g., the first subevent 702 corresponding to the Sub_Interval). SE_Length 704 indicating the length of each subevent may be designated by, for example, the Sub_Interval parameter among the CIS parameters (e.g., control data 600).

In an embodiment, during one subevent (e.g., the first subevent 702), the electronic device 101 may perform one transmission (e.g., C->P packet 706 transmitted from the electronic device 101 (the central device) to the first electronic device 202 (the peripheral device)) and one reception (e.g., P->C packet 710 transmitted from the first electronic device 202 (the peripheral device) to the electronic device 101 (the central device)). The first electronic device 202 may receive the C->P packet 706, and after the interval 708 of T_IFS, transmit a response (e.g., P->C packet 710) corresponding thereto. In an embodiment, upon failing to receive the packet 706 from the electronic device 101, the first electronic device 202 may perform no transmission during the first subevent 702. The electronic device 101 and the first external electronic device 202 may use the next subevent for retransmission (RT) of the packet 706 or transmission of the next packet.

There may be an interval of, at least, time for minimum subevent space (T_MSS) 712 until the first subevent 702 is terminated after the transmission (e.g., P->C packet 710) of the first electronic device 202. T_MSS 712 means the minimum time interval between the last bit of the last packet (e.g., P->C packet 710) in one subevent (e.g., the first subevent 702) and the first bit of the first packet of the next subevent and may be designated as, e.g., 150 micro seconds (μs) by the standard.

When the electronic device 101 and the first electronic device 202 complete transfer of the isochronous data scheduled in the CIS event, all the remaining subevents of the CIS event may have no more transmissions, and the CIS event may be terminated.

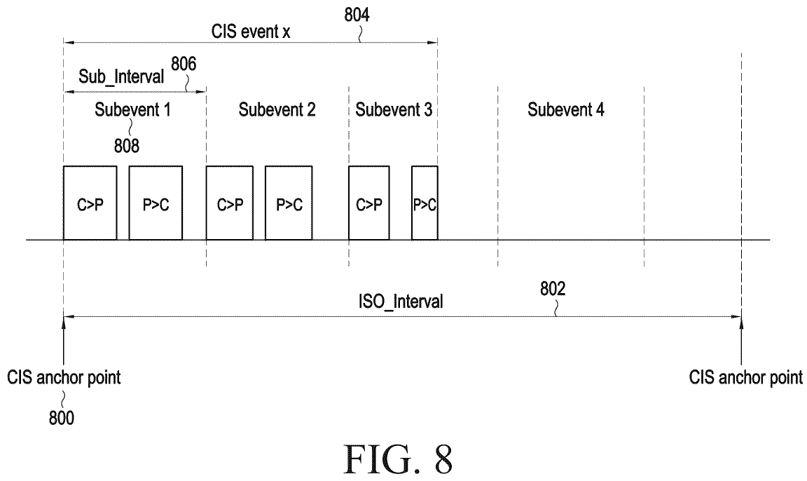

FIG. 8 illustrates an example of a CIS event according to an embodiment of the disclosure.

Referring to FIG. 8, at least one CIS event (e.g., CIS event x 804) may be included in the ISO_interval 802 for a CIS link. The CIS event x 804 means an occasion where the central device (e.g., the electronic device 101) and the peripheral device (e.g., the first electronic device 202) may exchange CIS packets (e.g., CIS PDUs), and may occur at predetermined intervals and include as many subevents (including subevent 1 808) as the NSE, at most. For example, if NSE=4, up to 4 subevents may be present in CIS event x 804, and in this case, a case where 3 subevents (e.g., subevent 1 808, subevent 2, and subevent 3) occur is shown. Each CIS event (e.g., CIS event x 804) may start at each CIS anchor point 800 until CIS communication is terminated, and a uniform spacing of the ISO_Interval 802 may be present between two contiguous CIS anchor points.

Each CIS event (e.g., CIS event x 804) may be divided into one or more subevents (including, e.g., subevent 1 808). In one subevent 1 808, there may be data transmission (“C->P”) from the central device (e.g., the electronic device 101) to the peripheral device (e.g., the first electronic device 202) and data transmission (“P->C”) from the peripheral device to the central device. The spacing of the Sub_Interval 806 may be present between the start points of two contiguous subevents in CIS event x 804.

The CIG is a bundle of CISs providing the same service, and the CIG may include one or more CISs. Several CISs in the CIG may have a common time reference with respect to the time of the central device (e.g., the electronic device 101) and may be synchronized in time units. The CIG may have a temporal relation at the application level. In one CIG, CISs may have the same ISO_Interval (e.g., ISO_Interval 802), and up to 31 CISs may be included in one CIG. The central device may allocate the CIG_ID and share the CIG_ID with the peripheral device (e.g., the first electronic device 202) through the LL message.

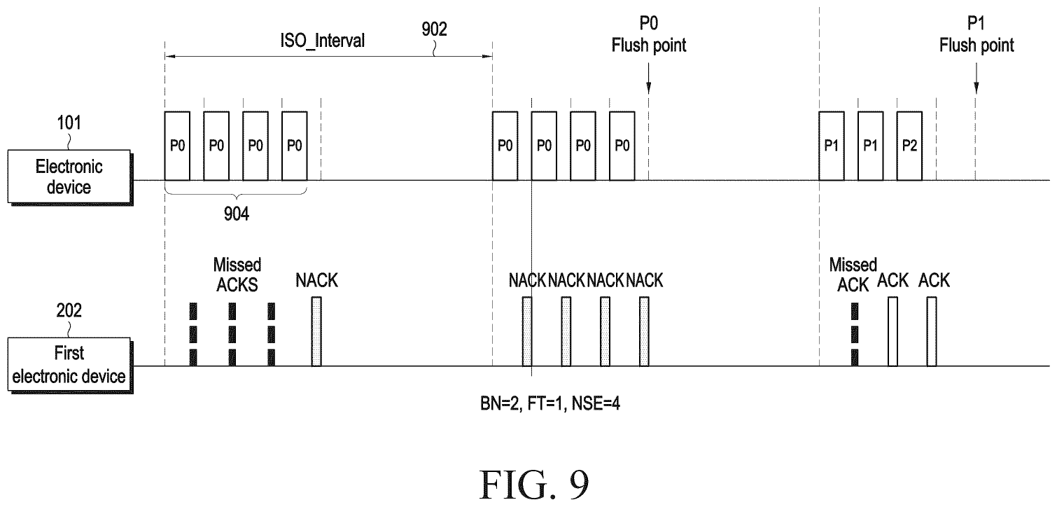

FIG. 9 illustrates an example of CIS transmission according to an embodiment of the disclosure.

Referring to FIG. 9, BN=2, FT=1, and NSE=4 may be configured for CIS transmission. During the first CIS event 902 having the ISO interval, the electronic device 101 may repeatedly transmit packet P0 using up to four subevents 904 according to NSE=4. For example, the first electronic device 202 may fail to normally receive packet P0 in four subevents 904 and may transmit a NACK by using the last fourth subevent.

Upon failing to successfully transmit packet P0 until reaching a flush point of packet P0 in the second CIS event, in other words, upon failing to receive an ACK for packet P0, the electronic device 101 may transmit the next packet P1 in the third CIS event. Upon receiving an ACK from the first electronic device 202 by using the second subevent of the third CIS event, the electronic device 101 may transmit the next packet P2 by using the third subevent of the third CIS event.

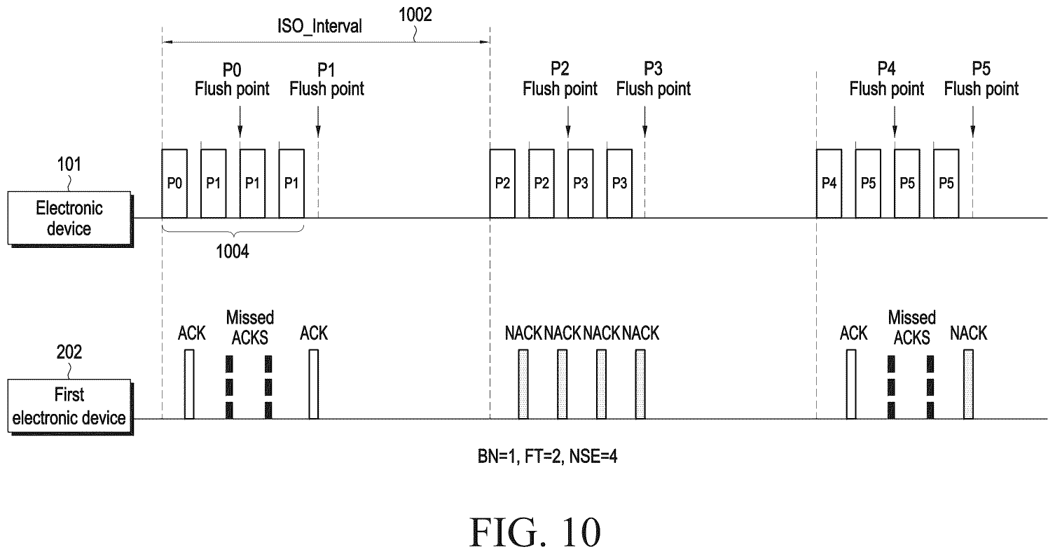

FIG. 10 illustrates another example of CIS transmission according to an embodiment of the disclosure.

Referring to FIG. 10, BN=1, FT=2, and NSE=4 may be configured for CIS transmission. During the first CIS event 1002 having the ISO interval, the electronic device 101 may use up to four subevents 1004 according to NSE=4. For example, in the first subevent, the electronic device 101 may transmit packet P0 and receive an ACK from the first electronic device 202. In the second, third, and fourth subevents, the electronic device 101 may repeatedly transmit packet P1, and in the fourth subevent, the first electronic device 202 may transmit an ACK for packet P1 to the electronic device 101.

For the second CIS event, the electronic device 101 may repeatedly transmit packet P2 by using the first and second subevents and repeatedly transmit packet P3 by using the third and fourth subevents. For the third CIS event, the electronic device 101 may transmit packet P4 by using the first subevent and repeatedly transmit packet P5 by using the second, third, and fourth subevents.

In an embodiment, the electronic device 101 may transmit CIS parameters (e.g., the control data 600) to the first electronic device 202 and the second electronic device 204 to transmit audio data by using CIS communication, thereby configuring the CIS parameters in the first electronic device 202 and the second electronic device 204. For example, for the media type, two CISs (e.g., the first CIS link 2022 and the second CIS link 2024) having the CIS parameters in which ISO interval=20 ms, BN=2, FT=5, NSE=6, and SE length=884 μs may be opened between the electronic device 101 and the first electronic device 202 and the second electronic device 204, and the audio service may be performed through the CISs.

In an embodiment, the resources for each CIS, available for one CIS to the electronic device 101, may be calculated as “SE length x NSE/ISO interval” so that the resources for a plurality of CISs may be “available resources for each CIS*CIS count.” Here, the CIS count may mean the number (e.g., two) of CISs included in one CIG. In an embodiment, the electronic device 101 may determine the resources by using the designated SE length, and the ISO interval and NSE among the CIS parameters (e.g., the control data 600) transmitted to the first electronic device 202 and the second electronic device 204.

The CIG may be expected to have a temporal relation at the application layer and may include Num_CIS of CISs having the same ISO interval. Here, Num_CIS may be equal to or smaller than 31. The host of the central device (e.g., the electronic device 101) may allocate a CIG_ID to the CIG. The CISs in each CIG may be arranged in a sequential, interleaved, or hybrid manner depending on the interval between CIS anchor points and the Sub_Interval. In an embodiment, a first CIS link related to the first electronic device 202 and a second CIS link related to the second electronic device 204 may be arranged in a hybrid manner. For example, a first CIS event in the first CIS link (e.g., the first CIS link 2022) may at least partially overlap with a second CIS event of the second CIS link (e.g., the second CIS link 2024) within one CIG event.

BIS may refer to logical transmission used to transmit one or more isochronous data streams to all devices for BIS within a designated range. The BIS may include one or more subevents for transmitting isochronous data packets (e.g., BIS data packets). The BIS may support transmission of several new isochronous data packets in all BIS events. The BIS does not include an acknowledgment protocol, and may be transmitted unidirectionally from a broadcasting device (e.g., a source electronic device) that broadcasts traffic. To enhance reliability of BIS logical transmission, isochronous data packets may be unconditionally retransmitted by increasing the number of subevents in all events. Transmission reliability may be enhanced by transmitting the isochronous data packets at an interval preceding an interval related to the isochronous data packets. This is referred to as pre-transmission. The BIS may be identified by a unique access address and time information. The access address and time information may be transmitted through a packet transmitted using corresponding periodic advertising broadcast logic transmission.

A scanning device (e.g., a sink electronic device) supporting a synchronized receiver role (e.g., a sink role) may receive isochronous data (e.g., isochronous data packets) from the BIS after synchronizing with the BIS by using the time information obtained from periodic advertising packets.

Each BIS may be a part of a broadcast isochronous group (BIG). The BIG may include two or more BISs having the same isochronous interval (e.g., ISO_Interval). BISs in the BIG have a common time reference based on the source electronic device, and may be temporally synchronized with each other. The maximum number of BISs in the BIG may have a designated value (e.g., 31). BIG may also include control subevents.

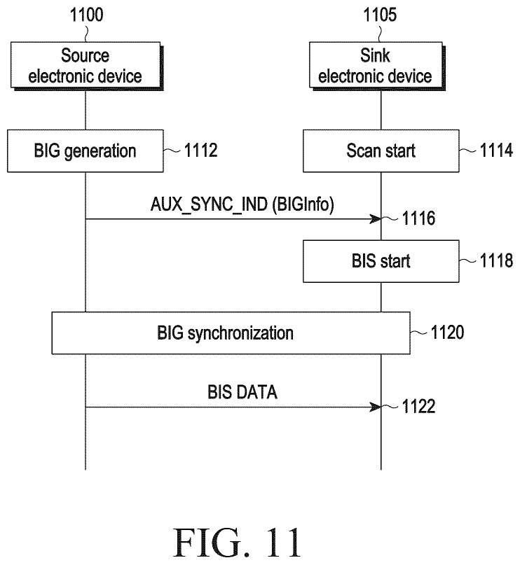

FIG. 11 illustrates a sequence diagram illustrating a procedure of synchronization with a broadcast isochronous group (BIG) according to an embodiment of the disclosure.

Referring to FIG. 11, in operation 1112, a source electronic device 1100 may create a BIG including one or more BISs and initiate periodic advertising related to the BIG. In operation 1114, for reception synchronization, a sink electronic device 1105 (e.g., at least one of the electronic device 101, the first electronic device 202, or the second electronic device 204) may initiate BLE scanning.

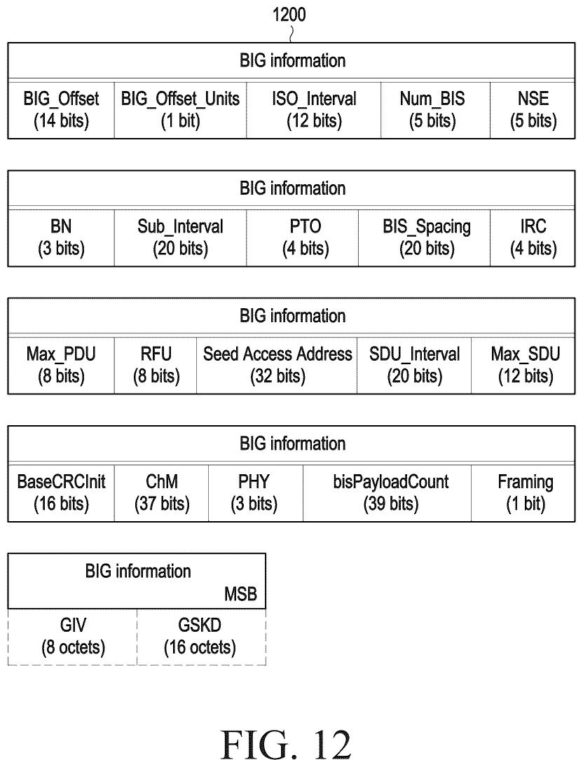

In operation 1116, the source electronic device 1110 may periodically transmit an advertising packet (e.g., AUX_SYNC_IND) related to the BIG at designated intervals. The AUX_SYNC_IND may include, for example, BIG information (e.g., the BIG information 1200 of FIG. 12) within an additional controller advertising data (ACAD) field. The BIG information may include parameters used for synchronization with the BIG (e.g., at least one BIS) provided by the source electronic device 1100. In an embodiment, the sink electronic device 1105 may directly receive the BIG information from the source electronic device 1100, receive, based on assistance from an external electronic device (e.g., the electronic device 101) operating as a BIS assistant role, the BIG information from the source electronic device 1100, or receive the BIG information from the external electronic device (e.g., the electronic device 101).

In an embodiment, the sink electronic device 1105 (e.g., at least one of the electronic device 101, the first electronic device 202, or the second electronic device 204) may receive the advertising packet through BLE scanning and obtain BIG information (e.g., the BIG information 1200) from the advertising packet. In an embodiment, the sink electronic device 1105 (e.g., the electronic device 101) may receive synchronization information required to receive the BIG information 1200 from the source electronic device 1100, and may transmit the synchronization information to an external electronic device (e.g., the first electronic device 202 or the second electronic device 204). In an embodiment, the sink electronic device 1105 (e.g., the first electronic device 202 or the second electronic device 204) may receive, based on the synchronization information received from the external electronic device (e.g., the electronic device 101), the advertising packet from the source electronic device 1100, and obtain the BIG information (e.g., the BIG information 1200) from the advertising packet.

In operation 1118, the sink electronic device 1105 may determine to start receiving the BIS based on the BIG information. In operation 1120, the sink electronic device 1105 may perform synchronization with the BIG of the source electronic device 1100 by using parameters included in the BIG information. In an embodiment, the BIG synchronization operation performed by the sink electronic device 1105 may include an operation of calculating, based on the BIG information, an access address and time information of transmission of audio data. In an embodiment, the time information may include channel information (e.g., a channel map) and transmission time points of audio data.

In operation 1122, the sink electronic device 1105 may receive audio data (e.g., at least one BIS data packet) broadcasted by the source electronic device 1100 through at least one BIS within the BIG.

FIG. 12 illustrates BIG parameters according to an embodiment of the disclosure.

Referring to FIG. 12, BIG information 1200 may include BIG parameters such as at least one of BIG_Offset, BIG_Offset_units, ISO_Interval, Num_BIS, number of subevent (NSE), burst number (BN), Sub_Interval, pre-transmission offset (PTO), BIS_Spacing, an immediate repetition count (IRC), Max_PDU, reserved for future use (RFU), SeedAccessAddress, SDU_Interval, Max_SDU, BaseCRCInit, a channel map (ChM), physical (PHY), bisPayloadCount, framing, a group initialization vector (GIV), or group session key derivation (GSKD). In an embodiment, the length of the BIG information 1200 may be 33 octets when not being encrypted, and 57 octets when being encrypted.

BIG parameters that may be included in the BIG information 1200 are described below.

Num_BIS indicates the number of BISs in the BIG. A different BIS_Number from 1 to Num_BIS may be allocated to each of the BISs in the BIG.

ISO_Interval may indicate a time interval of 1.25 ms between two adjacent BIG anchor points (e.g. 5 ms to 4 s).

BIS_Spacing may indicate a time interval between start time points of the subevents in adjacent BISs in the BIG and a start time of the first subevent of the last BIS.

Sub_Interval may indicate a time interval between start time points of two consecutive subevents of each BIS.

Max_PDU is the maximum number of data octets enabling transmission of each BIS data packet within the BIG and may indicate the maximum duration of the packet (e.g. 1 to 251 octets).

Max_SDU may indicate the maximum size (e.g., maximum duration) of the service data unit (SDU) in the BIG (e.g. 1 to 4095 octets).

BN, PTO, and IRC may include values for controlling data to be transmitted in each BIG event. Subevents of each BIS event may be divided into groups (e.g., subevent groups) including BN subevents. Accordingly, a group count (GC) is NSE/BN. IRC may designate the number of groups carrying data related to a current BIS event. The remaining groups may carry data related to future BIS events designated by the PTO.

IRC may be greater than 0 and may not be greater than GC. If IRC=GC, the PTO may be ignored, otherwise the PTO may be greater than zero. Groups of subevents may be sequentially numbered (e.g., group index g) from 0 to GC−1. When g<IRC, the group g may include data related to the current BIS event. When g>=IRC, group g may include data related to a future BIS event (e.g., PTO*(g−IRC+1)-th BIS event) after the current BIS event.

The NSE indicates the maximum number of subevents within each BIG event.

The framing field may indicate whether the BIG transmits framed data or unframed data.

BIG_Offset may indicate a time interval from a start time of a packet (e.g., AUX_SYNC_IND) including the BIG information 1200 to the next BIG anchor point. The value of BIG_Offset may be indicated in units indicated by bits of BIG_Offset_Units. The time offset is determined by multiplying the value of BIG_Offset by the unit indicated by BIG_Offset_Units. The time offset may be greater than 600 micro seconds (μs). When the bit of BIG_Offset_Units is set, the unit is 300 μs, otherwise 30 μs. The bit of BIG_Offset_Units may not be set if the time offset is less than 491,460 μs. The BIG anchor point may be between a time offset after the start time of the packet (e.g., AUX_SYNC_IND and a time offset plus 1 unit as follows.

The parameters included in the BIG information 1200 may not be changed during a lifetime of the BIG.

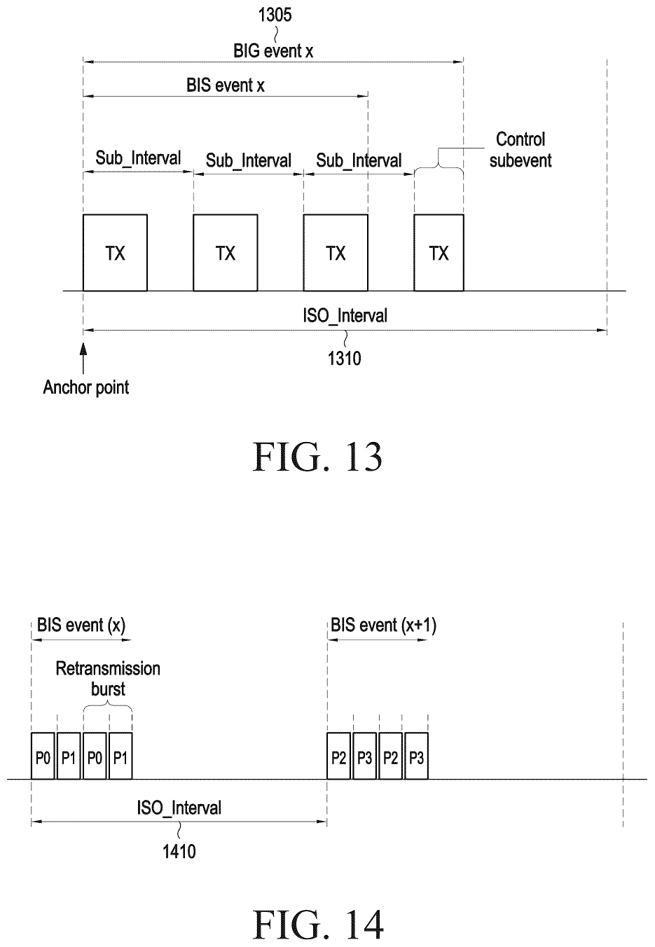

FIG. 13 illustrates a BIG event and a BIS event according to an embodiment of the disclosure.

Referring to FIG. 13, a BIG event (e.g., the BIG event x 1305) may include one or more BIS data packets (e.g., PDUs). A source electronic device (e.g., the source electronic device 1100) may transmit BIS data packets in BIG events (e.g., BIG event x 1305). Each BIG event (e.g., BIG event x 1305) may be divided into a Num_BIS of BIS events, and, if present, one control subevent. Each BIS event may be divided into NSE subevents.

Each BIS event may start at a BIS anchor point and end after the last subevent. Each BIG event (e.g., the BIG event x 1305) may start at the BIG anchor point, and if there is a control subevent, it may end thereafter, otherwise, end at the last constituent BIS event. The BIG anchor points may be regularly spaced apart by an interval of ISO_Interval 1310. The BIS anchor points for BIS n of the BIG may be after (n−1)×BIS_Spacing from the BIG anchor points, and may be regularly spaced apart by ISO_Interval 1310. The subevents of each BIS may be spaced apart by Sub_Interval. The source electronic device (e.g., the source electronic device 1100) may terminate the current BIG event (e.g., the BIG event x 1305) at least T_IFS (e.g., 150 μs) before the BIG anchor point of the next BIG event. The time interval between two consecutive packets on the same channel may be referred to as T_IFS. T_IFS may be defined as a time interval between a final point of a last bit of a previous packet and a start point of a first bit of a subsequent packet.

BISs in the BIG may be arranged sequentially or in the interleaved manner according to Sub_Interval and BIS_Spacing. In the case of sequential arrangement, BIS_Spacing may be greater than or equal to NSE×Sub_Interval, and all subevents of the BIS event may occur together. When being arranged in the interleaved manner, Sub_Interval may be Num_BIS×BIS_Spacing, the first subevents of all BISs may be adjacent, and the second subevents of all the following BISs may be adjacent.

The maximum length possible for a data part (except for the control subevent) of the BIG event may be indicated as BIG_Sync_Delay. The value of BIG_Sync_Delay may be the same as a time interval from the BIS anchor point to a BIG synchronization point, which is an end point of a packet including a payload of the Max_PDU octet transmitted in the last subevent (BIG_Sync_Delay=(Num_BIS−1)×BIS_Spacing+ (NSE−1)×Sub_Interval+MPT).

The BIS subevent is an opportunity for the source electronic device 1100 to transmit BIS data packets and for the sink electronic device 1105 (e.g., the electronic device 101, the first electronic device 202, or the second electronic device 204) operating as a sink to receive the BIS data packets. The source electronic device 1100 may transmit one BIS data packet at a time point at which each BIS subevent of the BIS event starts, and may transmit, for example, at least one BIS packet within six consecutive BIS events.

For each BIS event, the source electronic device 1100 may provide a data burst including BN payloads. Each payload may include a single fragment or one or more SDU segments. One data burst is related to a designated BIS event, but may be transmitted in earlier events.

FIGS. 14, 15, and 16 illustrate retransmission of BIS data packets according to various embodiments of the disclosure.

Referring to FIG. 14, in the BIS having BN=2, IRC=2, PTO=0, and NSE=4, payloads may be allocated to BIS subevents in each BIS event. One BIS event corresponding to ISO_Interval 1410 may include a maximum of NSE (=4) BIS subevents. BIS data packets each including two payloads (e.g., P0 and P1 or P2 and P3) in each BIS event (e.g., BIS event x or BIS event x+1) may be allocated to two earlier BIS subevents, and the remaining subevents may be used for retransmission of the same BIS data packets (e.g., P0 and P1 or P2 and P3).

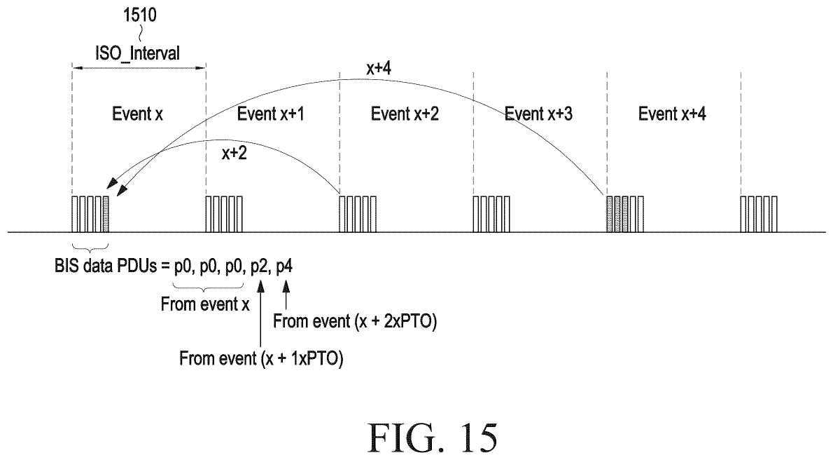

Referring to FIG. 15, in a BIS having BN=1, IRC=3, PTO=2, and NSE=5, payloads may be allocated to BIS subevents in each BIS event. One BIS event corresponding to ISO_Interval 1510 may include a maximum of NSE (=5) BIS subevents. In the BIS event x, BIS data packet p0 may be transmitted in earlier three BIS subevents, BIS data packet p2 for BIS event x+2 may be transmitted in the fourth BIS subevent, and BIS data packet p4 for BIS event x+4 may be transmitted in the last BIS subevent. Accordingly, BIS data packet p2 may be repeatedly transmitted in BIS event x and BIS event x+2, and BIS data packet p4 may be repeatedly transmitted in BIS event x and BIS event x+4.

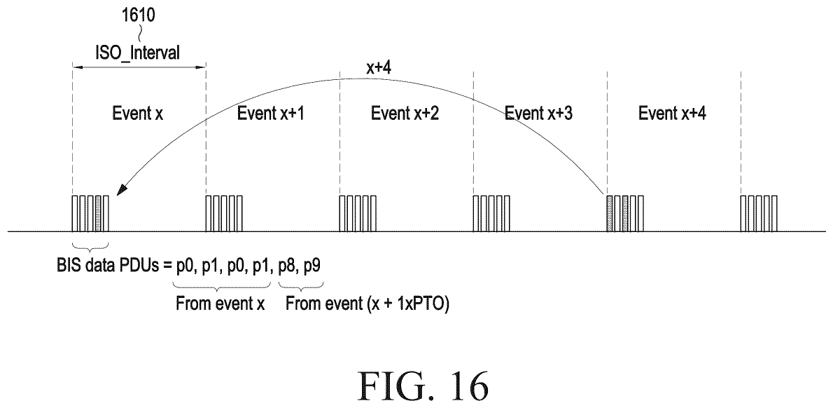

Referring to FIG. 16, in a BIS having BN=2, IRC=2, PTO=4, and NSE=6, payloads may be allocated to BIS subevents in each BIS event. One BIS event corresponding to ISO_Interval 1610 may include a maximum of NSE (=6) BIS subevents. BIS data packets p0 and p1 may be transmitted in earlier four BIS subevents in BIS event x, and BIS data packets p8 and p9 for BIS event x+4 may be transmitted in the last two BIS subevents. Accordingly, BIS data packets p8 and p9 may be repeatedly transmitted in BIS event x and BIS event x+4.

Among various types of Bluetooth topology, a first electronic device 202 and a second electronic device 204 included in an ear wearable device (e.g., the electronic device 102) such as a TWS may receive audio data of different channels (e.g., a left channel and a right channel) of the same audio service. For example, the second electronic device 204 may obtain, in a snipping scheme, audio data received from an external electronic device (e.g., the electronic device 101) by the first electronic device 202. For example, in the BLE audio topology, the first electronic device 202 and the second electronic device 204 may use audio communication links (e.g., CIS links) separately from the external electronic device (e.g., the electronic device 101) to use the Bluetooth audio service.

The first electronic device 202 and the second electronic device 204 may perform bridge communication with each other for various purposes such as exchanging states with each other and/or changing of operation parameters. For example, in the ear wearable deice such as the TWS, the first electronic device 202 corresponding to the left channel and the second electronic device 204 corresponding to the right channel may obtain information on a communication state (e.g., a communication deterioration situation) of the counterpart electronic device through bridge communication (e.g., communication between TWS).

In an embodiment, the first electronic device 202 and the second electronic device 204 may use a fixed and restricted communication time (e.g., a communication time between TWS) on a communication link for bridge communication while using a connection-based or connectionless-based audio service with the external electronic device (e.g., the electronic device 101). In this case, at a time point at which the communication time between TWS conflicts with the communication time of the audio service, there is possibility that degradation in the quality of the audio service or deterioration of the communication between TWS occurs.

According to an operation of Bluetooth communication, a peripheral electronic device (e.g., the first electronic device 202 or the second electronic device 204) may activate (e.g., open) a reception circuit (e.g., a reception circuit of the communication circuit 320) at a specific cycle and a specific time point (e.g., slots) to receive data packets transmitted from a central electronic device (e.g., the electronic device 101). However, the first electronic device 202 which performs the peripheral role for the central electronic device (e.g., the electronic device 101) and simultaneously maintains a communication link for bridge communication with the secondary electronic device (e.g., the second electronic device 204) may allocate, for the communication link with the second electronic device 204, some of wireless link resources available for reception of data packets from the electronic device 101, and accordingly, at a time point at which the data packets are received from the electronic device 101, a conflict with the bridge communication may occur. Likewise, the second electronic device 204 may experience a conflict between the communication with the electronic device 101 and the communication with the first electronic device 202. Accordingly, resources between the first electronic device 101 and the first electronic device 202 and second electronic device 204 may be wasted, and degradation of the Bluetooth communication performance may be caused.

Audio packets received from a primary electronic device (e.g., the first electronic device 202) operating as a sink electronic device of an audio service and a secondary electronic device (e.g., the second electronic device 204), respectively, may be reproduced at substantially the same time point. The source electronic device (e.g., the electronic device 101) of the audio service may not re-transmit a specific audio packet after a predetermined time interval. In a period in which timing in which the electronic device 101 transmits an audio packet and timing in which the first electronic device 202 and the second electronic device 204 communicate with each other overlap, the first electronic device 202 and/or the second electronic device 204 may omit at least one audio packet, which may cause degradation of the audio service, such as audio chopping.

According to embodiments of the disclosure, when two or more electronic devices (e.g., the first electronic device 202 and/or the second electronic device 204) receive a connection-based or connectionless-based audio service from an external electronic device (e.g., the electronic device 101 or the source electronic device 1100) while performing bridge communication (e.g., communication between TWS), at least one electronic device (e.g., the first electronic device 202) may calculate or obtain timing (e.g., one or more time periods which can be defined by a start time point and an interval) in which the counter electronic device (e.g., the second electronic device 204) receives the audio service, and may perform bridge communication by avoiding the calculated or obtained timing.

Embodiments of the disclosure can guarantee quality of the audio service of electronic devices (e.g., the first electronic device 202 and/or the second electronic device 204) performing bridge communication, and reduce a probability that the bridge communication time and the audio service time conflicts, thereby minimizing the waste of unnecessary resources. Accordingly, the efficiency of the link operation can be increased and the quality of the audio service can be increased.

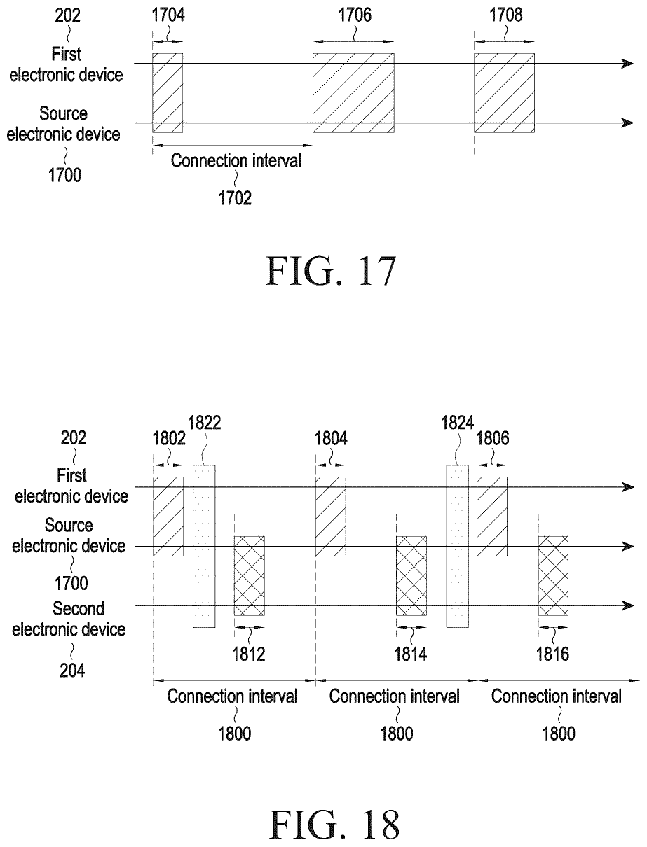

FIG. 17 illustrates a time for Bluetooth communication according to an embodiment of the disclosure.

Here, an operation of the first electronic device 202 is illustrated and described, but the same description is also applicable to the second electronic device 204.

Referring to FIG. 17, the first electronic device 202 may start to receive an audio service from a source electronic device 1700 (e.g., the electronic device 101 or the source electronic device 1100) or determine to receive the audio service. The first electronic device 202 may identify a time (e.g., a reception time point 1704, a reception time point 1706, and a reception time point 1708) for receiving audio data transmitted by the source electronic device 1700 on the communication link in each connection interval 1702, and may activate a reception circuit (e.g., the reception circuit of the communication circuit 320) at the reception time point 1704, the reception time point 1706, and the reception time point 1708 so as to monitor, through the reception circuit, reception of audio data (e.g., at least one audio data packet) transmitted from the source electronic device 1700.

FIG. 18 illustrates reallocation times for bridge communication and an audio service according to an embodiment of the disclosure.

Referring to FIG. 18, the first electronic device 202 may establish a first communication link (e.g., a communication link for bridge communication) with the second electronic device 204. The first electronic device 202 and the second electronic device 204 may determine to receive an audio service from a source electronic device 1800 (e.g., the electronic device 101 or a source electronic device 2410), or start to receive the audio service.

The first electronic device 202 may identify a first time for receiving or transmitting audio data from the source electronic device 1700 within each connection interval (e.g., connection intervals 1800) on a second communication link. In an embodiment, the first time may include one or more time periods (e.g., a time period 1802, a time period 1804, and a time period 1806) which can be defined by a start time point and an interval. In an embodiment, at least one of the time period 1802, the time period 1804, or the time period 1806 may include an opportunity for transmission of audio data and/or an opportunity for transmission of response data (e.g., ACK/NACK) relate to the audio data.

The second electronic device 204 may identify a second time for receiving or transmitting audio data from the source electronic device 1800 on a third communication link. In an embodiment, the second time may include one or more time periods (e.g., a time period 1812, a time period 1814, and a time period 1816) which can be defined by a start time point and an interval. In an embodiment, at least one of the time period 1812, the time period 1814, or the time period 1816 may include an opportunity for transmission of audio data and/or an opportunity for transmission of response data (e.g., ACK/NACK) related to the audio data.

The first electronic device 202 and/or the second electronic device 204 may share information on the first time and the second time. In an embodiment, the first electronic device 202 and/or the second electronic device 204 may share first information related to the first time and second information related to the second time at a designated time point (e.g., a time point at which a start intend of the audio service is identified, a start time point of the audio service, a designated time point after the audio service starts, and/or a designated periodic time point). In an embodiment, the first electronic device 202 and/or the second electronic device 204 may directly calculate or exchange the first information and/or the second information, based on the information (e.g., the control data 600 or the BIG information 1200) received from the source electronic device 1800, at the designated time point. In an embodiment, the first electronic device 202 and/or the electronic device 204 may receive the first information and/or the second information from an external electronic device (e.g., the electronic device 101).

The first electronic device 202 and/or the second electronic device 204 may determine a communication time for a first communication link so that the first time and the second time do not conflict (e.g., do not at least partially overlap). In an embodiment, the communication time may include one or more time periods (e.g., a time period 1822 and a time period 1804) which can be defined by a start time point and an interval).

The first electronic device 202 may receive audio data (e.g., left channel audio data) from the source electronic device 1800 through the second communication link at the reception time point 1802, and may communicate with the second electronic device 204 through the first communication link in the time period 1822 determined not to overlap with the time period 1802. The second electronic device 204 may communicate with the first electronic device 202 through the first communication link in the time period 1822 determined not to overlap with the time period 1812, and may receive audio data (e.g., right channel audio data) from the source electronic device 1800 through third communication link at the reception time point 1812.

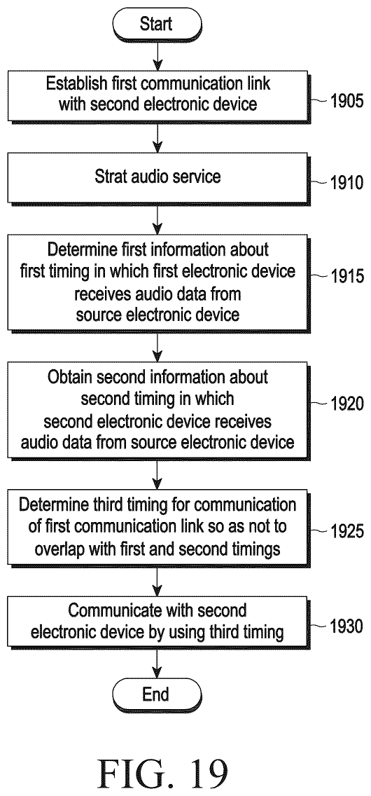

FIG. 19 is a flowchart illustrating an operation of adjusting a time for bridge communication to avoid a conflict with audio communication according to an embodiment of the disclosure.

According to embodiments, at least one of the operations to be described below may be omitted or changed, or the sequence thereof may be changed. According to an embodiment, at least one of the operations to be described below may be executed by a first electronic device 202 (e.g., the processor 310). Here, the operations to be described below are illustrated and described by the first electronic device 202, but the same description is also applicable to a second electronic device 204.

Referring to FIG. 19, in operation 1905, the first electronic device 202 (e.g., the processor 310) may create a first communication link with the second electronic device 204. In an embodiment, the first electronic device 202 and the second electronic device 204 may include a pair of electronic devices (e.g., ear wearable devices or multi-channel audio reception devices) configured to receive at least one audio service (e.g., different channel data of the same audio service or different audio services).

In an embodiment, the first communication link may include a Bluetooth communication link (e.g., a BT/BLE ACL link or near field magnetic induction (NFMI) communication) for bridge communication between the first electronic device 202 and the second electronic device 204 (e.g., communication between TWS). In an embodiment, the first communication link may be used to exchange a connection state or operation information of an audio service between the first electronic device 202 and the second electronic device 204. In an embodiment, the first electronic device 202 and the second electronic device 204 may connect the first communication link based on a designated event, for example, detachment of the first electronic device 202 and the second electronic device 204 from a cradle device (e.g., the external electronic device 250).

In operation 1910, the first electronic device 202 (e.g., the processor 310) may start to receive an audio service from the source electronic device 1800 (e.g., the electronic device 101 or the source electronic device 1100) or determine to receive the audio service. In an embodiment, the first electronic device 202 (e.g., the processor 310) may establish a second communication link (e.g., a CIS link) for the audio service (e.g., a CIS-type BLE audio service). In an embodiment, the first electronic device 202 may connect the second communication link based on reception of a connection request for starting the CIS-type BLE audio service from the source electronic device 1800. In an embodiment, the first electronic device 202 (e.g., the processor 310) may be synchronized with a BIG for the audio service (e.g., a BIS-type BLE audio service). In an embodiment, the first electronic device 202 may be synchronized with the BIG based on BIG parameters (e.g., BIG information 1200) received from the source electronic device 1800.

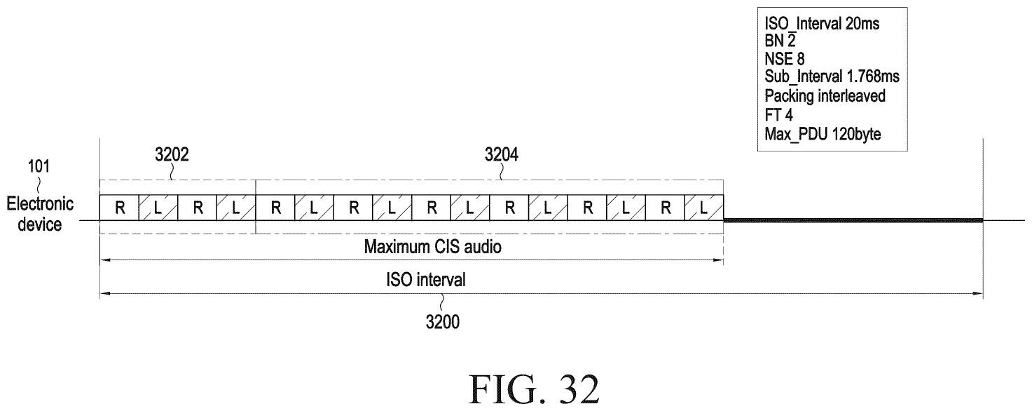

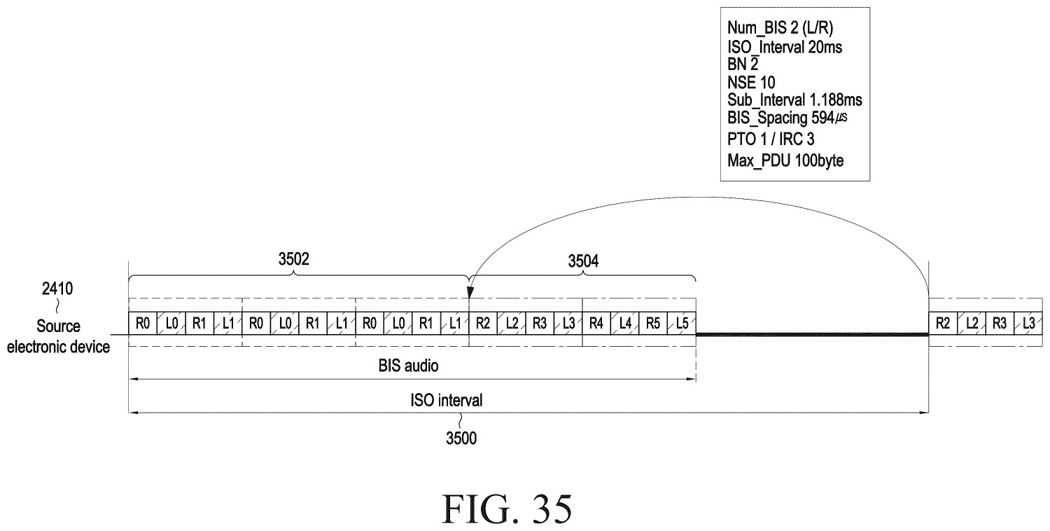

In operation 1915, the first electronic device 202 (e.g., the processor 310) may determine first information related to a first time (e.g., the time periods 1802, 1804, and 1806) in which the first electronic device 202 receives first audio data (e.g., left channel audio) of the audio service from the source electronic device 1800. In an embodiment, the first electronic device 202 may calculate the first information based on the parameters (e.g., control data 600 or BIG information 1200) obtained from the source electronic device 1800. In an embodiment, the first time may include a time period (e.g., a time period in which left channel audio packets (“L” packets) are received between a time period 3202 of FIG. 32 and a time period 3502 of FIG. 35) to be guaranteed for the first electronic device 202 to receive first audio data of the audio service from the source electronic device 1800.

In an embodiment, the first electronic device 202 may calculate, based on the ISO_Interval, BN, NSE, Sub_Interval, FT, and/or Max_PDU among the CIS parameters included in the control data 600, a first time (e.g., the time period 3202 of FIG. 32) in which the first electronic device 202 receives first audio data (e.g., left channel audio) of the audio service from the source electronic device 1800. In an embodiment, the first electronic device 202 may calculate, based on the Num_BIS, ISO_Interval, BN, NSE, Sub_Interval, BIS_spacing, PTO, and/or Max_PDU among the BIG parameters included in the BIG information 1200, a first time (e.g., the time period 3502 of FIG. 35) in which the electronic device 202 receives first audio data (e.g., left channel audio) of the audio service from the source electronic device 1800.

Although not shown, in an embodiment, the first electronic device 202 may transmit the first information to the second electronic device 204. In an embodiment, the first information may be transmitted to the second electronic device 204 through a first communication link. In an embodiment, alternatively, the first information may be transmitted from the first electronic device 202 to the second electronic device 204 through an external electronic device (e.g., the electronic device 101). In an embodiment, the first information may be obtained by the external electronic device (e.g., the electronic device 101) and transmitted to the second electronic device 204.

In operation 1920, the first electronic device 202 (e.g., the processor 310) may obtain second information related to a second time (e.g., the time periods 1812, 1814, and 1816) in which the second electronic device 204 receives second audio data (e.g., right channel audio) of the audio service from the source electronic device 1800. In an embodiment, the second time may include a time period (e.g., a time period in which right channel audio packets (“R” packets”) are received between the time period 3202 of FIG. 32 and the time period 3502 of FIG. 35) which need to be guaranteed for the second electronic device 204 to receive second audio data of the audio service from the source electronic device 1800. In an embodiment, the second time may be related to an audio service identical to or different from the first time.

In an embodiment, the first electronic device 202 may calculate the second information by itself without cooperation of the second electronic device 204. In an embodiment, the first electronic device 202 may determine the second information based on the parameters (e.g., the control data 600 or the BIG information 1200) obtained from the source electronic device 1800. In an embodiment, the first electronic device 202 may receive the second information from the second electronic device 204. In an embodiment, the first electronic device 202 may make an inquiry to the second electronic device 204 about the second information.

In operation 1925, the first electronic device 202 (e.g., the processor 310) may determine a third time (e.g., the time periods 1822 and 1824) to be used for the first communication link so as not to be overlapped with the first time and the second time. In an embodiment, the first electronic device 202 may determine the third time through a time negotiation with the second electronic device 204. In an embodiment, the first electronic device 202 may share information on the third time with the second electronic device 204. In an embodiment, the information on the third time may include at least one of a start time point, an interval length, or an interval.

In operation 1930, the first electronic device 202 (e.g., the processor 310) may communicate with the second electronic device 204 through the first communication link by using the third time while receiving the audio service. In an embodiment, the first electronic device 202 may transmit at least one data packet to the second electronic device 204 in at least one time period (e.g., the time periods 1822 and 1824) of the third time. In an embodiment, the first electronic device 202 may receive at least one data packet from the second electronic device 204 in at least one time period (e.g., the time periods 1822 and 1824) of the third time.

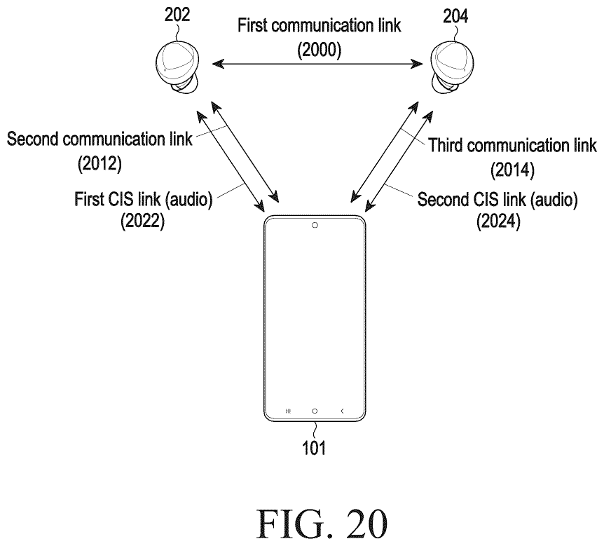

FIG. 20 illustrates topology of a CIS audio service according to an embodiment of the disclosure.

Referring to FIG. 20, a first electronic device 202 (e.g., the left channel earbud) may know device information of a second electronic device 204 configured to operate as a pair by software implementation or a user request, and establish, based on the device information by a designated event (e.g., cradle open), a first communication link 2000 with the second electronic device 204. The first electronic device 202 may accept the connection request from the electronic device 101, or may create a second communication link 2012 (e.g., an ACL link) with the electronic device 101 by transmitting the connection request to the electronic device 101 having the last connection history according to software implementation. The first electronic device 202 may create a first CIS link 2022 based on a second communication link 2012 with the electronic device 101 according to at least one of a user request, an operation of a specific application, or an input of a specific menu. In an embodiment, the first electronic device 202 may create the first CIS link 2022 based on the previous connection history (e.g., pre-stored CIS parameters).

The first electronic device 202 may identify whether the second electronic device 204 performs an audio service or a time (e.g., the second time) for performing the audio service directly from the second electronic device 204, or indirectly through information (e.g., CIS parameters in the control data 600) obtained from the electronic device 101. The first electronic device 202 may consider both the time (e.g., the first time) for receiving the audio service of the first electronic device 202 and the time (e.g., the second time) for receiving the audio service of the second electronic device 204 so as to negotiate with the second electronic device 204 to reconfigure a new communication time (e.g., the third time) of the first communication link 2000 so that there is no influence on the reception of the audio services of the first electronic device 202 and the second electronic device 204 or the influence is minimized.\

In an embodiment, the first electronic device 202 may consider both the time (e.g., the first time) for communication between the first electronic device 202 and the electronic device 101 through the second communication link 2012 and the time (e.g., the second time) for communication between the second electronic device 204 and the electronic device 101 through the third communication link 2014, so as to determine the third time of the first communication link 2000 so that there is no influence on the communication of the first electronic device 202 through the second communication link 2012 and the communication of the second electronic device 204 through the third communication link 2014, or the influence is minimized.

The second electronic device 204 (e.g., the right channel earbud) may know device information of the first electronic device 202 configured to operate as a pair by software implementation or a user request, and establish, based on the device information by a designated event (e.g., cradle open), a first communication link 2000 with the first electronic device 202. The second electronic device 204 may accept the connection request from the electronic device 101, or transmit a connection request to the electronic device from the electronic device 101 having the last connection history according to software implementation to create a third communication link 2014 (e.g., an ACL link) with the electronic device 101. The second electronic device 204 may create a second CIS link 2024 based on the third communication link 2014 with the electronic device 101 according to at least one of a user input, an operation of a specific application, or an input of a specific menu. In an embodiment, the second electronic device 204 may create the second CIS link 2024 based on the previous connection history (e.g., pre-stored CIS parameters).

The second electronic device 204 may identify whether the first electronic device 202 performs an audio service and a time (e.g., the first time) for performing the audio service directly from the first electronic device 202, or indirectly through the electronic device 101. The second electronic device 204 may consider both the communication time (e.g., the first time) for performing the audio service of the first electronic device 202 and the communication time for performing the audio service of the second electronic device 204, so as to negotiate with the first electronic device 202 to re-configure a new communication time (e.g., the third time) of the first communication link 2000 so that there is no influence on the reception of the audio services of the second electronic device 204 and the first electronic device 202 or the influence is minimized.

In an embodiment, the second electronic device 204 may consider both the time (e.g., the first time) for communication between the first electronic device 202 and the electronic device 101 through the second communication link 2012 and the time (e.g., the second time) for communication between the second electronic device 204 and the electronic device 101 through the third communication link 2014, so as to determine the third time of the first communication link 2000 so that there is no influence on the communication of the first electronic device 202 and the second electronic device 204 or the influence is minimized.

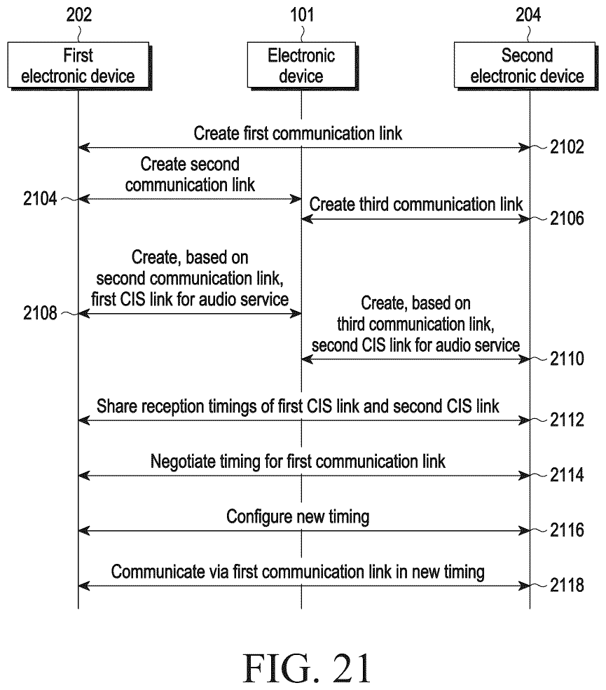

FIG. 21 is a sequence diagram illustrating an operation of negotiating a bridge communication time in consideration of a CIS audio service according to an embodiment of the disclosure.

Referring to FIG. 21, in operation 2102, the first electronic device 202 and the second electronic device 204 may create a first communication link 2000 for bridge communication. In operation 2104, the first electronic device 202 may create a second communication link 2012 (e.g., an ACL link) with the electronic device 101. In operation 2106, the second electronic device 204 may create a third communication link 2014 (e.g., an ACL link) with the electronic device 101.

In operation 2108, the first electronic device 202 may create a first CIS link 2022 for an audio service based on the second communication link. In operation 2110, the second electronic device 204 may create a second CIS link 2024 for an audio service based on the third communication link.

In operation 2112, the first electronic device 202 and the second electronic device 204 may share communication times (e.g., a first time and a second time) of the first CIS link and the second CIS link. In an embodiment, the first electronic device 202 and the second electronic device 204 may calculate the first time and the second time from CIS parameters (e.g., the control data 600) obtained from the electronic device 101. In an embodiment, the first electronic device 202 and the second electronic device 204 may exchange information on the first time and the second time.

In operation 2114, the first electronic device 202 and the second electronic device 204 may negotiate a time (e.g., the third time) for the first communication link 2000 so that the time does not conflict with the first time and the second time. In an embodiment, the third time may be determined by at least one of the first electronic device 202 and the second electronic device 204 so that the third time does not at least partially overlap with the communication times of the second communication link and the third communication link. In an embodiment, the first electronic device 202 and the second electronic device 204 may exchange information for the third time.

In operation 2116, the first electronic device 202 and the second electronic device 204 may configure the first communication link 2000 to use the third time. In operation 2118, the first electronic device 202 and the second electronic device 204 may perform bridge communication through the first communication link 2000 by using the third time.

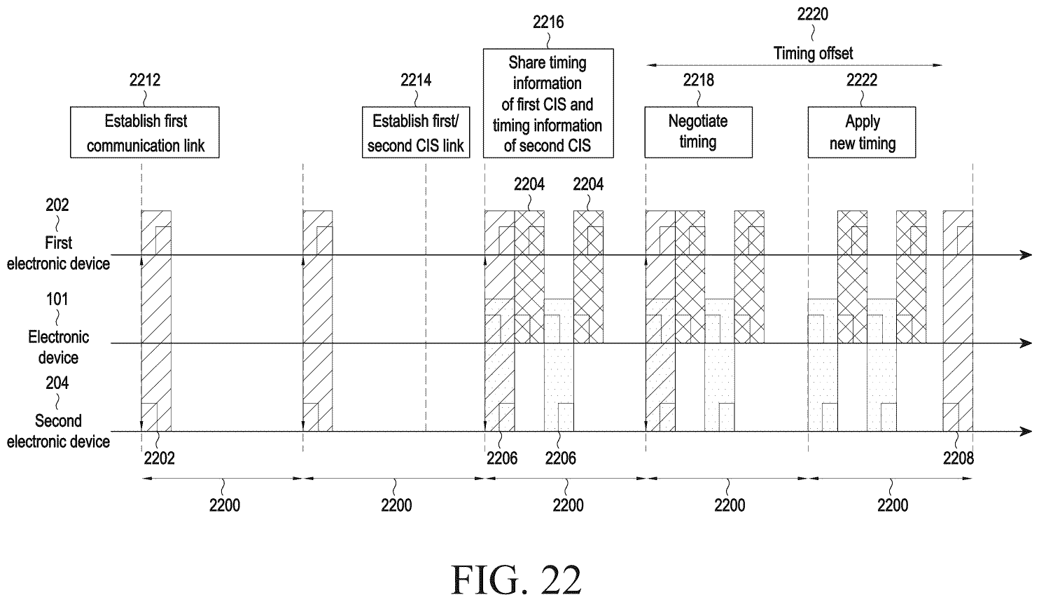

FIG. 22 illustrates a procedure of avoiding a conflict during a CIS operation according to an embodiment of the disclosure.

Referring to FIG. 22, in operation 2212, the first electronic device 202 and the second electronic device 204 may establish a first communication link 2000. In an embodiment, a time resource (e.g., a time) available for the first communication link 2000 may be designated as a time period 2202 at a designated location in each connection interval (e.g., a connection interval 2200).

In operation 2214, the first electronic device 202 and the second electronic device 204 may establish a first CIS link 2022 and a second CIS link 2024, respectively, with the electronic device 101 to start an audio service. In an embodiment, a time resource (e.g., a first time) available for the first CIS link 2022 may be designated as a time period (e.g., the first time period 2204) at a designated location in each connection interval (e.g., the connection interval 2200). In an embodiment, a time resource (e.g., a second time) available for a second CIS link 2024 may be designated as a time period (e.g., the second time period 2206) at a designated location in each connection interval (e.g., a connection interval 2200).

In operation 2216, the first electronic device 202 and the second electronic device 204 may share time information (e.g., first information related to the first time) of the first CIS link 2022 and time information (e.g., second information related to the second time) of the second CIS link 2024. In operation 2218, the first electronic device 202 and the second electronic device 204 may negotiate a new time (e.g., a third time period 2208) for the first communication link 2000 so that the new time does not overlap with the first time period 2204 and the second time period 2206. In an embodiment, the third time period 2208 may be determined to start after a designated time offset 2220 from an anchor point of the connection interval in which time negotiation is performed.

In operation 2222, the first electronic device 202 and the second electronic device 204 may communicate with each other (e.g., bridge communication) through the first communication link 2000 in the new time (e.g., the third time period 2208) in which there is no conflict with a CIS audio service while receiving the CIS audio service in the first time and the second time.

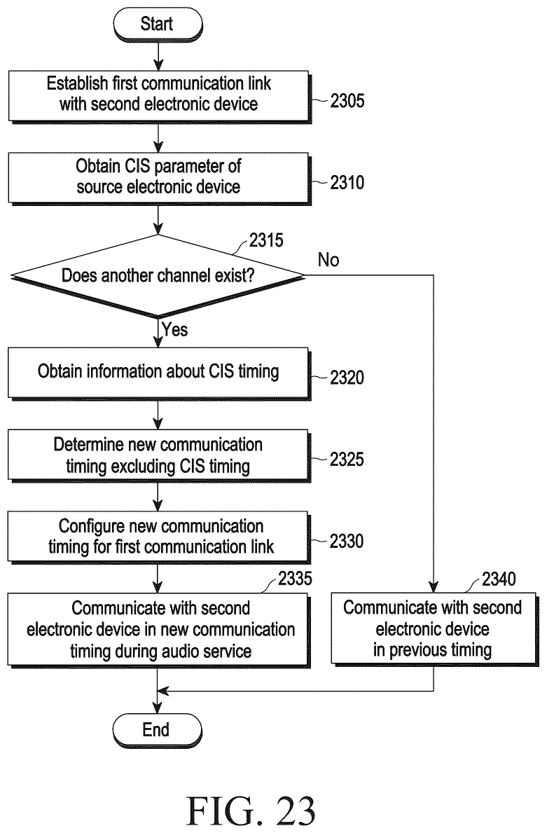

FIG. 23 is a flowchart illustrating a procedure of adjusting a bridge communication time in consideration of a CIS audio service according to an embodiment of the disclosure. According to embodiments, at least one of the operations to be descried below may be omitted or changed, or the sequence thereof may be changed. According to an embodiment, at least one of the operations to be described below may be executed by a first electronic device 202 (e.g., the processor 310). Here, it is illustrated and described that the operations to be described are performed by the first electronic device 202, but the same description is also applicable to a second electronic device 204.

Referring to FIG. 23, in operation 2305, the first electronic device 202 (e.g., the processor 310) may create (e.g., establish) a first communication link 2000 with the second electronic device 204. In operation 2310, the first electronic device 202 (e.g., the processor 310) may obtain CIS parameters (e.g., the control data 600) for an audio service of an external electronic device (e.g., the electronic device 101) operating as a central role, and create a first CIS link 2022 by using the CIS parameters. In an embodiment, the first electronic device 202 (e.g., the processor 310) may establish a second communication link 2012 (e.g., an ACL link) with the electronic device 101 and establish a first CIS link 2022 based on the second communication link 2012. In an embodiment, the first electronic device 202 (e.g., the processor 310) may receive the CIS parameters (e.g., the control data 600) from the electronic device 101. In an embodiment, the first electronic device 202 (e.g., the processor 310) may read, from the memory 390, the CIS parameters pre-stored according to a connection history.

In operation 2315, the first electronic device 202 may determine whether there is the second electronic device 204 for receiving an audio channel (e.g., a right channel) other than an audio channel (e.g., a left channel) for the first electronic device 202. In an embodiment, the first electronic device 202 may determine whether there is the second electronic device 204 for establishing the first communication link 2000. In an embodiment, the first electronic device 202 may determine, based on the CIS parameters, whether the audio service includes the audio channel (e.g., the right channel) other than the audio channel (e.g., the left channel) for the first electronic device 202. If there is no second electronic device 204 for receiving other audio channel, the first electronic device 202 (e.g., the processor 310) may proceed to operation 2340. In an embodiment, the first electronic device 202 (e.g., the processor 310) may proceed to operation 2340 when determining that the second electronic device 204 does not normally operate. On the other hand, when there is the second electronic device 204 for receiving other audio channel, the first electronic device 202 (e.g., the processor 310) may proceed to operation 2320.

In operation 2320, the first electronic device 202 (e.g., the processor 310) may obtain information on CIS communication times (e.g., a first time and a second time) of audio channels for the audio service. In an embodiment, the first electronic device 202 (e.g., the processor 310) may share information (e.g., first information about the first time) on a start time point and a time interval of the first CIS link 2022 with the second electronic device 204. In an embodiment, the first electronic device 202 (e.g., the processor 310) may make an inquiry to the second electronic device 204 about information (e.g., second information about the second time) on a start time point and a time interval of a second CIS link 2024 used by the second electronic device 204 and obtain the information. In an embodiment, the first electronic device 202 (e.g., the processor 310) may identify the information of the start time point and the time interval of the second CIS link 2024 used by the second electronic device 204, the information being received from the second electronic device 204.

In operation 2325, the first electronic device 202 (e.g., the processor 310) may calculate, based on the CIS communication times (e.g., the first time and the second time) of the first electronic device 202 and the second electronic device 204, an idle time period not overlapping with the first time and the second time, and calculate, based on the idle time period (e.g., within the idle time period), a start time point and a time interval (e.g., a third time) to be allocated to the first communication link 2000. Although not shown, in an embodiment, the first electronic device 202 (e.g., the processor 310) may proceed to operation 2340 without determining a new communication time when detecting that the CIS communication times (e.g., the first time and the second time) of the first electronic device 202 and the second electronic device 204 do not overlap with a pre-configured communication time of the first communication link 2000.

In operation 2330, the first electronic device 202 (e.g., the processor 310) may re-configure, for the first communication link 2000, the start time point and the time interval (e.g., the third time) calculated for the first communication link 2000. In an embodiment, the first electronic device 202 (e.g., the processor 310) may provide information on the third time to the second electronic device 204.

In operation 2335, the first electronic device 202 (e.g., the processor 310) may perform bridge communication with the second electronic device 204 through the first communication link 2000 in the third time when receiving the audio service in the CIS communication time (e.g., the first time) through the second CIS link.

In operation 2340, the first electronic device 202 (e.g., the processor 310) may perform bridge communication with the second electronic device 204 by using a pre-configured communication time of the first communication link 2000.

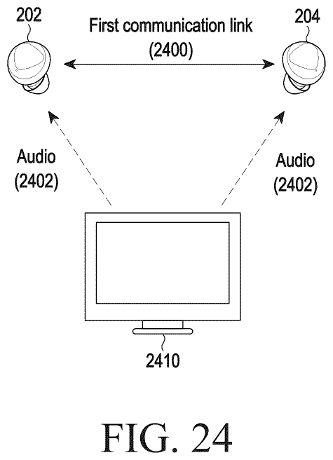

FIG. 24 illustrates topology for a BIS audio service according to an embodiment of the disclosure.

Referring to FIG. 24, a source electronic device 2410 (e.g., the electronic device 101) may broadcast audio data through a BIG including at least one BIS 2402. In an embodiment, the source electronic device 2410 may include a mobile phone or a television (TV) operating as a BIS source role. The first electronic device 202 and the second electronic device 204 may be configured to be synchronized with at least one BIS 2402 of the source electronic device 2410 and receive audio data. The at least one BIS 2402 may carry multi-channel audio data (e.g., left channel audio and right channel audio). The first electronic device 202 may be configured to receive left channel audio through the at least one BIS 2402. The second electronic device 204 may be configured to receive the right channel audio through the at least one BIS 2402. In an embodiment, the first electronic device 202 and the second electronic device 204 may be configured to perform bridge communication though the first communication link 2400.

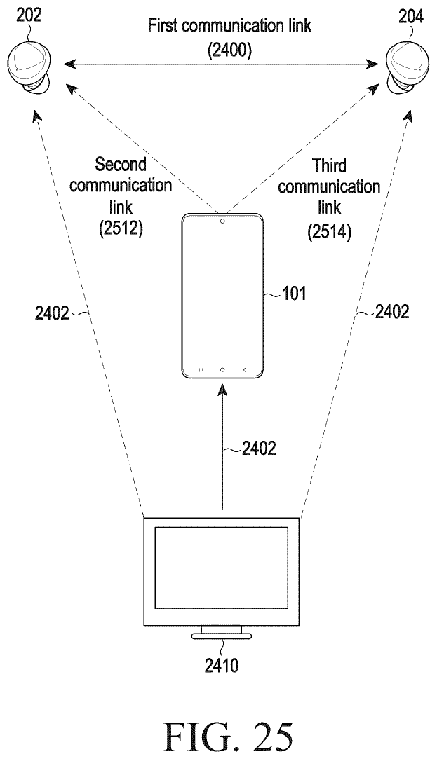

FIG. 25 illustrates topology for an assistant-based BIS audio service according to an embodiment of the disclosure.

Referring to FIG. 25, a first electronic device 202 (e.g., a left channel earbud) may know device information of a second electronic device 204 configured to operate as a pair by software implementation or a user request, and establish, based on the device information by a designated event (e.g., cradle open), a first communication link 2400 with a second electronic device 204.

In an embodiment, the first electronic device 202 may be directly synchronized with at least one BIS of a source electronic device 2410 through BLE scanning according to at least one of a user request, an operation of a specific application, or an input of a specific menu.

In an embodiment, the first electronic device 202 may accept a connection request of the electronic device 101, or transmit a connection request to the electronic device 101 having the last connection history according software implementation to create a second communication link 2512 (e.g., an ACL link) with the electronic device 101 operating as a BIS assistant role. The first electronic device 202 may be synchronized with at least one BIS of the source electronic device 2410 through assistance of the electronic device 101 according to at least one of the user request, the operation of the specific application, or the input of the specific menu.

The first electronic device 202 may identify whether the second electronic device 204 receives an audio service and a time (e.g., a second time) for performing the audio service directly from the second electronic device 204, or indirectly through the electronic device 101 or the source electronic device 2510. The first electronic device 202 may consider both a time (e.g., a first time) for receiving an audio service of the first electronic device 202 and a time (e.g., a second time) for receiving an audio service of the second electronic device 204, so as to negotiate with the second electronic device 204 to re-configure a new communication time (e.g., a third time) of the first communication link 2400 so that there is no influence on the reception of the audio service of the first electronic device 202 and the second electronic device 204 or the influence is minimized.

The second electronic device 204 (e.g., the right channel earbud) may know device information of the first electronic device 202 configured to operate as a pair by software implementation or a user request, and may establish, based on the device information by a designated event (e.g., cradle open), a first communication link 2400 with the first electronic device 202.

In an embodiment, the second electronic device 204 may be directly synchronized with at least one BIS of the source electronic device 2410 through BLE scanning according to at least one of a user request, an operation of a specific application, or an input of a specific menu.

In an embodiment, the second electronic device 204 may accept a connection request of the electronic device 101, or transmit a connection request to the electronic device 101 having the last connection history according to software implementation so as to create a third communication link 2514 (e.g., an ACL link) with the electronic device 101 operating as a BIS assistant role. The first electronic device 202 may be synchronized with the source electronic device 2410 through assistance of the electronic device 101 according to at least one of the user request, the operation of the specific application, or the input of the specific menu.

The second electronic device 204 may identify whether the first electronic device 202 receives an audio service and a communication time (e.g., a first time) for performing the audio service directly from the first electronic device 202, or indirectly through the electronic device 101. The second electronic device 204 may consider both a communication time (e.g., a first time) for performing the audio service of the first electronic device 202 and a communication time (e.g., a second time) for performing the audio service of the second electronic device 204, so as to negotiate a new communication time (e.g., a third time) of the first communication link 2000 with the first electronic device 202 so that there is no influence on the reception of the audio service of the second electronic device 204 and the first electronic device 202 or the influence is minimized.

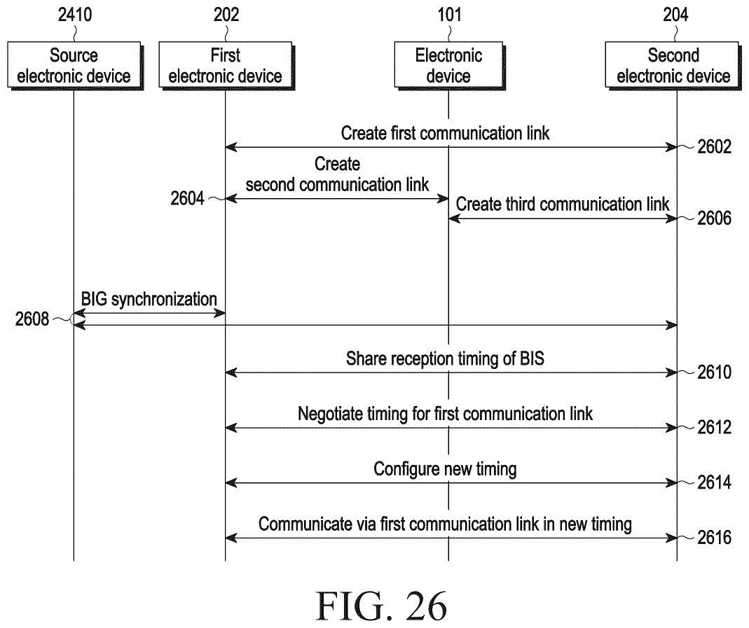

FIG. 26 is a sequence diagram illustrating an operation of negotiating a bridge communication time in consideration of a BIS audio service according to an embodiment of the disclosure.

Referring to FIG. 26, in operation 2602, the first electronic device 202 and the second electronic device 204 may create a first communication link 2400 for bridge communication. In operation 2604, the first electronic device 202 may create a second communication link 2512 with the electronic device 101. In operation 2606, the second electronic device 204 may create a third communication link 2514 with the electronic device 101. In an embodiment, the electronic device 101 may include a source electronic device 2410, and in this case, the operations of the source electronic device 2410 to be described below need to be understood to be performed by the electronic device 101.

In operation 2608, the first electronic device 202 and the second electronic device 204 may be synchronized with a BIS (e.g., at least one BIS) of the source electronic device 2410 for the audio service. In an embodiment, the first electronic device 202 and the second electronic device 204 may receive synchronization information from the electronic device 101 or the source electronic device 2410, and may receive BIG parameters (e.g., BIG information 1200 in AUX_SYNC_IND) from the source electronic device 2410 by using the synchronization information. The first electronic device 202 and the second electronic device 204 may be synchronized, based on the BIG parameters, with at least one BIS of the source electronic device 2410.

In operation 2610, the first electronic device 202 and the second electronic device 204 may share reception times (e.g., a first time and a second time) of a BIS. In an embodiment, at least one of the first electronic device 202 and the second electronic device 204 may directly calculate both the first time and the second time from BIG parameters (e.g., BIG information 1200) obtained from the source electronic device 2510. In an embodiment, the first electronic device 202 and the second electronic device 204 may exchange information on the first time and the second time. In an embodiment, the first electronic device 202 and the second electronic device 204 may exchange information on the first time and the second time through the electronic device 101, or may receive information of the first time and the second time from the electronic device 101.

In operation 2612, the first electronic device 202 and the second electronic device 204 may negotiate a time (e.g., a third time) for the first communication link 2400 so that the time does not conflict with the first time and the second time. In an embodiment, the first electronic device 202 and the second electronic device 204 may exchange information on the third time. In operation 2614, the first electronic device 202 and the second electronic device 204 may configure a first communication link 2400 to use the third time. In operation 2616, the first electronic device 202 and the second electronic device 204 may perform bridge communication through the first communication link 2400 by using the third time while receiving the BIS audio service through at least one BIS.

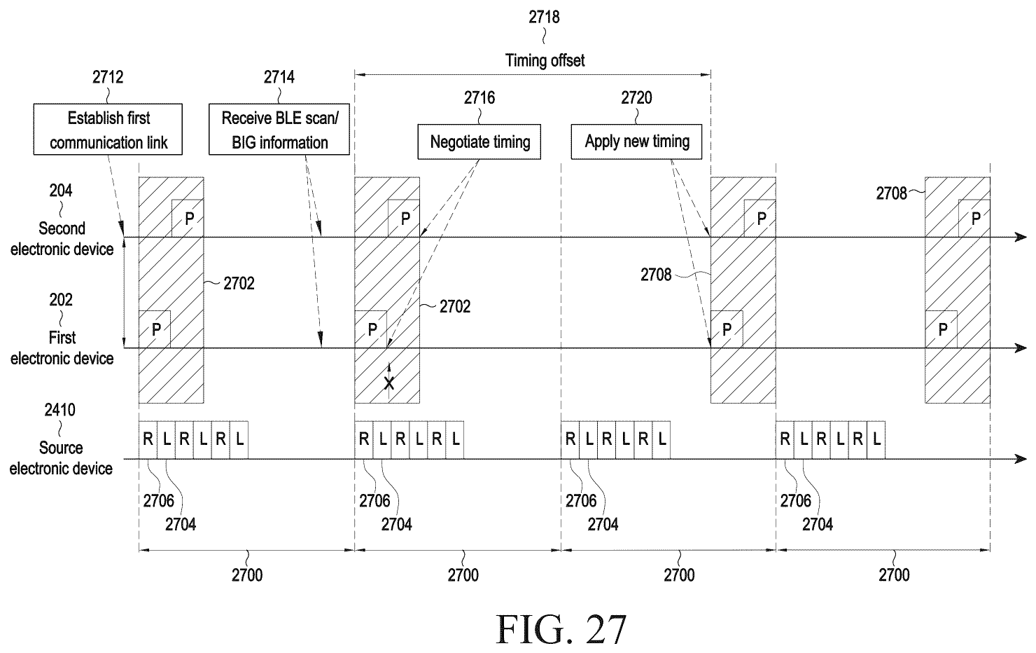

FIG. 27 illustrates a procedure of avoiding a conflict during a BIS operation according to an embodiment of the disclosure.

Referring to FIG. 27, in operation 2712, the first electronic device 202 and the second electronic device 204 may establish a first communication link 2400. In an embodiment, a time resource (e.g., a time) available for the first communication link 2400 may be designated as time periods 2702 at a designated location within each connection interval (e.g., connection intervals 2700). In operation 2714, each of the first electronic device 202 and the second electronic device 204 may obtain BIG parameters (e.g., BIG information 1200) of the source electronic device 2410. The first electronic device 202 and the second electronic device 204 may calculate, based on the BIG parameters, a reception time for a BIS audio service.

In an embodiment, a time resource (e.g., a first time) available for the first electronic device 202 to receive the BIS audio service may include time periods (e.g., first time periods 2706) in which left channel audio (e.g., “R” packets) in each connection (e.g., connection intervals 2700) is transmitted. In an embodiment, a time resource (e.g., a second time) available for the second electronic device 204 to receive the BIS audio service may include time periods (e.g., second time periods 2204) in which right channel audio (e.g., “L” packets) in each connection interval (e.g., connection intervals 2700) is transmitted.

In operation 2716, the first electronic device 202 and the second electronic device 204 may negotiate a new time (e.g., a third time period 2708) for the first communication link 2400 so that the new time does not overlap with the first time period 2706 and the second time period 2704. In an embodiment, the third time period 2708 may be determined to start after a designated time offset 2718 from an anchor point of a connection interval in which time negotiation is performed.

In operation 2720, the first electronic device 202 and the second electronic device 204 may perform bridge communication through the first communication link 2400 by applying the new time (e.g., the third time period 2708) not conflicting with the BIS audio service while receiving the BIS audio service.

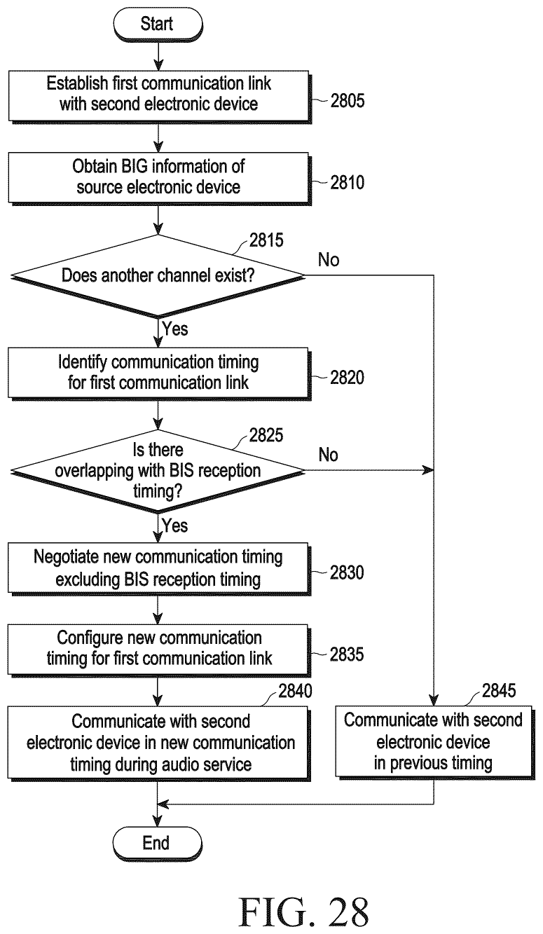

FIG. 28 is a flowchart illustrating a procedure of adjusting a bridge communication time in consideration of a BIS audio service according to an embodiment of the disclosure. According to embodiments, at least one of the operations to be described below may be omitted or changed, or the sequence thereof may be changed. According to an embodiment, at least one of the operations to be described may be executed by the first electronic device 202 (e.g., the processor 310). Here, the operations to be described are illustrated and described to be performed by the first electronic device 202, but the same description is also applicable to the second electronic device 204.

Referring to FIG. 28, in operation 2805, the first electronic device 202 (e.g., the processor 310) may create (e.g., establish) a first communication link 2400 with the second electronic device 204. In operation 2810, the first electronic device 202 (e.g., the processor 310) may obtain BIG parameters (e.g., BIG information 1200) for a BIS audio service of the source electronic device 2410. In an embodiment, the first electronic device 202 (e.g., the processor 310) may directly scan the source electronic device 2410 and receive periodic advertising data including the BIG information from the source electronic device 2410. In an embodiment, the first electronic device 202 (e.g., the processor 310) may receive periodic advertising data including BIG information from the source electronic device 2410 by using synchronization information of the source electronic device 2410 provided from the electronic device 101. In an embodiment, the first electronic device 202 (e.g., the processor 310) may be synchronized, based on the BIG information, with the BIG of the source electronic device 2410.

In an embodiment, the first electronic device 202 (e.g., the processor 310) may calculate, based on the BIG parameters, a BIS reception time (e.g., a first time) in which the first electronic device 202 receives BIS audio data through a BIG. In an embodiment, the first electronic device 202 (e.g., the processor 310) may calculate, based the BIG parameters, a BIS reception time (e.g., a second time) in which the second electronic device 204 receives BIS audio data through the BIG. In an embodiment, the first electronic device 202 (e.g., the processor 310) may directly calculate a first time and a second time from BIG information of the source electronic device 2410. In an embodiment, the first electronic device 202 (e.g., the processor 310) may receive information on the second time from the second electronic device 204. In an embodiment, the first electronic device 202 (e.g., the processor 310) may make an inquiry to the second electronic device 204 about information on the second time.

In operation 2815, the first electronic device 202 (e.g., the processor 310) may determine whether there is the second electronic device 204 for receiving an audio channel (e.g., a right channel) other than an audio channel (e.g., a left channel) for the first electronic device 202. In an embodiment, the first electronic device 202 (e.g., the processor 310) may determine whether there is the second electronic device 204 for establishing the first connection link 2400.

In an embodiment, the first electronic device 202 (e.g., the processor 310) may determine, based on the BIG parameters, whether the audio service includes the audio channel (e.g., the right channel) other than the audio channel (e.g., the left channel) for the first electronic device 202. When there is no second electronic device 204 for receiving other audio channel, the first electronic device 202 (e.g., the processor 310) may proceed to operation 2845. In an embodiment, the first electronic device 202 (e.g., the processor 310) may proceed to operation 2845 when determining that the second electronic device 204 does not normally operate. On the other hand, the first electronic device 202 (e.g., the processor 310) may proceed to operation 2820 when there is the second electronic device 204 for receiving the other audio channel.

In operation 2820, the first electronic device 202 (e.g., the processor 310) may identify a connection time of the first communication link 2400. In an embodiment, when the first electronic device 202 (e.g., the processor 310) calculates only the first time in operation 2810, the first electronic device 202 (e.g., the processor 310) may additionally calculate or obtain, based on the identification that there is the second electronic device 204 for receiving the other audio channel in operation 2815, the second time.

In operation 2825, the first electronic device 202 (e.g., the processor 310) may determine whether a communication time of the first communication link 2400 at least partially overlaps with BIS reception times (e.g., the first time and the second time) of audio channels for the audio service. In an embodiment, the BIS reception times may include the first time indicating a time period in which the first electronic device 202 receives left channel audio and the second time indicating a time period in which the second electronic device 204 receives right channel audio.

When the communication time of the first communication link 2400 does not overlap with the BIS reception times, the first electronic device 202 (e.g., the processor 310) may proceed to operation 2845. On the other hand, when the communication time of the first communication link 2400 at least partially overlaps with the BIS reception times, the first electronic device 202 (e.g., the processor 310) may proceed to operation 2830.

In operation 2830, the first electronic device 202 (e.g., the processor 310) may calculate, based on the BIS reception times (e.g., the first time and the second time), an idle time period not overlapping with the first time and the second time, and may calculate a start time point and a time period (e.g., a third time) to be allocated to the first communication link 2400 among the idle time period.

In operation 2835, the first electronic device 202 (e.g., the processor 310) may re-configure, for the first communication link 2400, the start time point and the time period (e.g., the third time) calculated for the first communication link 2400. In an embodiment, the first electronic device 202 (e.g., the processor 310) may provide information on the third time to the second electronic device 204.

In operation 2840, the first electronic device 202 (e.g., the processor 310) may perform bridge communication with the second electronic device 204 through the first communication link 2400 in the third time while receiving the audio service (e.g., the left channel audio) in the BIS reception time (e.g., the first time).

In operation 2845, the first electronic device 202 (e.g., the processor 310) may perform bridge communication with the second electronic device 204 by using a pre-configured communication time of the first communication link 2400.

In an embodiment, a first communication link (e.g., the first communication link 2000 or the first communication link 2400) are based on Bluetooth legacy or BLE, and may be used to exchange data packets between the first electronic device 202 and the second electronic device 204 for, for example, bridge communication, and carry acknowledgement (ACK) on the data packets. The Bluetooth legacy-based first communication link (e.g., the first communication link 2000 or the first communication link 2400) may be established through paging and paging scan. The BLE-based first communication link (e.g., the first communication link 2000 or the first communication link 2400) may be established through advertising and BLE scan.

In an embodiment, the first electronic device 202 may recognize the second electronic device 204 by using wireless communication (e.g., Bluetooth legacy or BLE). The second electronic device 204 may transmit advertising data in a multicast scheme or a broadcast scheme. The advertising data may carry information related to a connection to an unspecified peripheral electronic device (e.g., audio source) or an account (e.g., pairing) by using wireless communication (e.g., BLE). In an embodiment, the second electronic device 204 may be stored in a designated case (e.g., the external electronic device 250 such as a cradle), and the advertising data may start to be generated when the case (e.g., the external electronic device 250) is open while the second electronic device 204 is being stored. In an embodiment, when the case (e.g., the external electronic device 250) is open, the case (e.g., the external electronic device 250) may start to generate the advertising data related to the second electronic device 204.

In an embodiment, the advertising data may include at least one of identification information (hereinafter, device identification information) of the second electronic device 204, a user's account information (hereinafter, user account information), information (hereinafter, current pairing information) on whether there is currently pairing with another device (e.g., the electronic device 101), a list of previously paired devices (hereinafter, a pairing list), information (e.g., hereinafter, simultaneous pairing information) on devices which can be simultaneously paired, and information (hereinafter, battery state information) on transmission power, a detection area, or remaining battery power.

In an embodiment, the second electronic device 204 may transmit the advertising data according to a designated condition. For example, the second electronic device 204 may output, based on at least one of a designated time period or a user input, the advertising data when power is supplied.

The first electronic device 202 may be configured to establish a first communication link (e.g., the first communication link 2000 or the first communication link 2400) with the second electronic device 204 in the Bluetooth legacy scheme. For example, the first electronic device 202 and the second electronic device 204 may be connected to each other by performing paging and paging scan at a time point of separation from a case (e.g., the external electronic device 250 such as a cradle) for charging and storage. In an embodiment, in the first communication link (e.g., the first communication link 2000 or the first communication link 2400), the first electronic device 202 may be a primary electronic device operating as a central role, and the second electronic device 204 may be secondary electronic device operating as a peripheral role.

The first communication link (e.g., the first communication link 2000 or the first communication link 2400) may be used for the first electronic device 202 and the second electronic device 204 to exchange state information, media packet retransmission, or link operation information with each other. For example, the state information may include at least one of the version, the battery state, the wearing state, or the connection state of each earbud (e.g., the first electronic device 202 or the second electronic device 204).

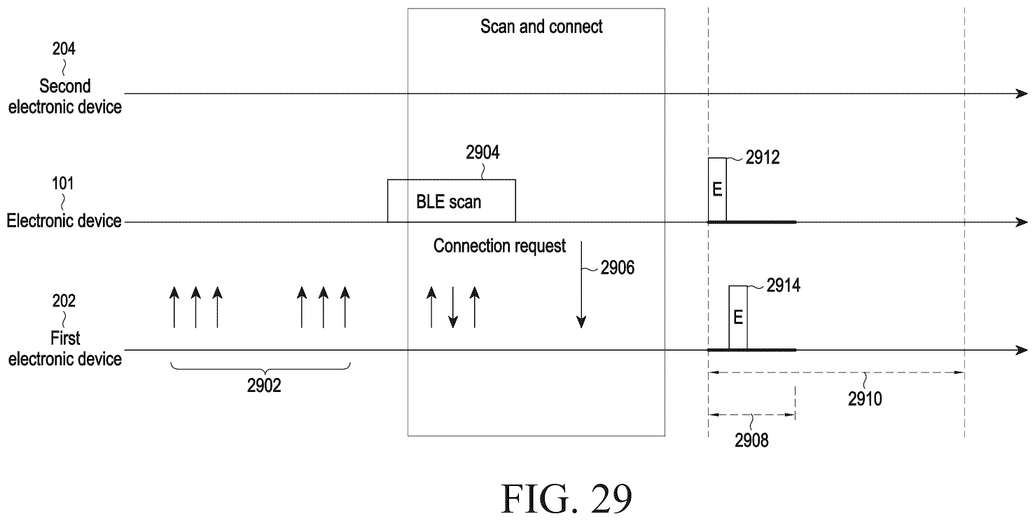

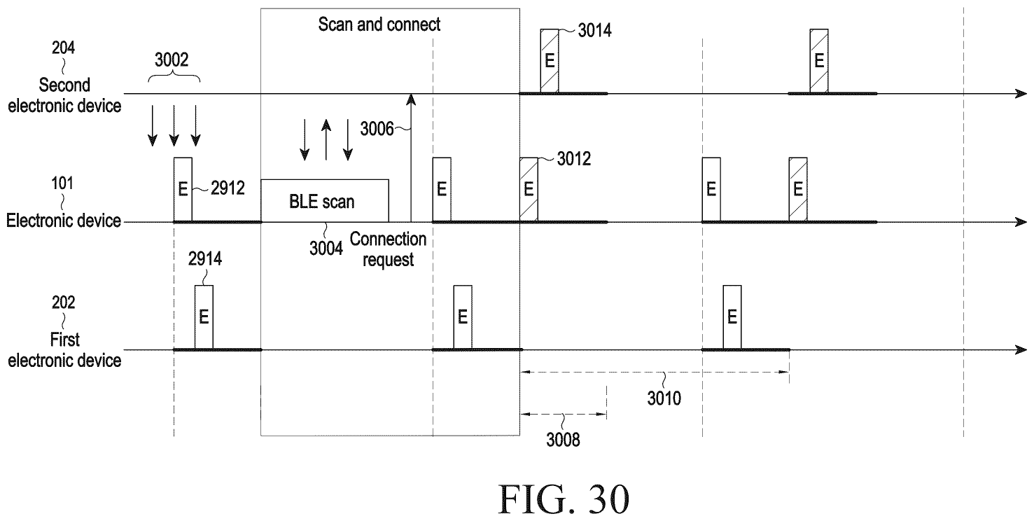

FIGS. 29 and 30 illustrate establishment of CIS links according to various embodiments of the disclosure.

Referring to FIG. 29, the first electronic device 202 may periodically transmit advertising data 2902 (e.g., one or more advertising PDUs). In an embodiment, the first electronic device 202 may start to transmit the advertising data 2902 at a time point at which a designated criterion such as case open or power supply is identified. The transmission of the advertising data 2902 may be performed before, after, or simultaneously with advertising/BLE scan or paging/paging scan for generation of a first communication link (e.g., the first communication link 2000 or the first communication link 2400).

The electronic device 101 may detect at least one advertising data 2902 through BLE scan 2904. The electronic device 101 may establish a second communication link (e.g., a first CIS link 2022) by transmitting a connection request 2906 (e.g., a CIS_REQ packet 3102) to the first electronic device 202. The first electronic device 202 and the electronic device 11 may exchange empty (E) packets 2912 and 2914 through the first CIS link 2022 to identify the establishment of the first CIS link 2022. A connection interval 2910 of the first CIS link 2022 may start from a start point of the first E packet 2912 transmitted by the electronic device 101, and an event length 2908 starting from the start point may be a transmission opportunity unit (e.g., one CIS event) of the first CIS link 2022.

Referring to FIG. 30, the second electronic device 204 may periodically transmit advertising data 3002 (e.g., one or more advertising PDUs). In an embodiment, the advertising data 3002 may be transmitted during, before, or after exchange of E packets 2912 and 2914 between the electronic device 101 and the first electronic device 202. In an embodiment, the second electronic device 204 may start to transmit the advertising data 3002 at a time point at which a designated criterion such as case open or power supply is identified. The transmission of the advertising data 3002 may be performed before, after, or simultaneously with advertising/BLE scan or paging/paging scan for generation of a first communication link (e.g., the first communication link 2000 or the first communication link 2400).

The electronic device 101 may detect at least one advertising data 3002 through BLE scan 3004. The electronic device 101 may establish a third communication link (e.g., a second CIS link 2024) by transmitting a connection request 3006 (e.g., a CIS_REQ packet 3102) to the second electronic device 204. The second electronic device 204 and the electronic device 101 may identify the establishment of the second CIS link 2024 by exchanging empty (E) packets 3012 and 3014 through the second CIS link 2024. A connection interval 3010 of the second CIS link 2024 may start from a start point of the first E packet 3012 transmitted by the electronic device 101, and an event length 3008 starting from the start point may be a transmission opportunity unit (e.g., one CIS event) of the second CIS link 2024.

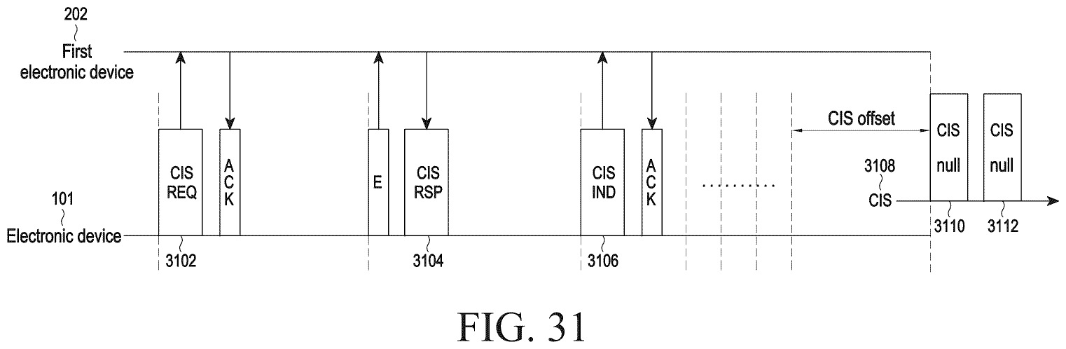

FIG. 31 illustrates generation of a CIS link according to an embodiment of the disclosure.

Referring to FIG. 31, the electronic device 101 may create a first CIS link 2022 with the first electronic device 202 and a second CIS link 2024 with the second electronic device 204 by a request from the first electronic device 202, a request from the second electronic device 204, or various methods such as a user input, a specific application operation, or menu entry. In an embodiment, the electronic device 101 may create the two CIS links 2022 and 2024 within one CIG, or may create the two CIS links 2022 and 2024 within two CIG, respectively. In an embodiment, the electronic device 101 may create the two CIS links 2022 and 2024 by using different CIS parameter sets within one CIG, respectively.

The electronic device 101 may transmit a CIS_REQ packet 3102 for establishment of the first CIS link 2022 through the second communication link 2012 to the first electronic device 202. The first electronic device 202 may transmit a CIS_RSP packet 3104 to the electronic device 101 through the second communication link 2012. The electronic device 101 may transmit a CIS_IND packet 3106 to the first electronic device 202 through the second communication link 2012. The electronic device 101 and the first electronic device 202 may identify establishment of the first CIS link (e.g., a CIS link 3108) by exchanging CIS null packets 3110 and 3112 through the first CIS link 2022 (e.g., the CIS link 3108) after a designated time point (e.g., the first anchor point) after the CIS_IND packet 3106.

The establishment of the first CIS link 2022 for the first electronic device 202 has been illustrated and described above, but the second CIS link 2024 for the second electronic device 204 may be also established through a similar procedure.

In embodiments of the disclosure, the first electronic device 202 and the second electronic device 204 may transmit or receive information on whether an audio service is operated and audio service operation information to or from each other at various time points. In an embodiment, the first electronic device 202 may transmit information (e.g., first information) related to the operation of the audio service in response to an inquiry request from the counterpart electronic device (e.g., the second electronic device 204). In an embodiment, the first electronic device 202 may transmit information (e.g., first information) related to the operation of the audio service to the counter electronic device (e.g., the second electronic device 204), or receive information (e.g., second information) related to the operation of the audio service from the counter electronic device (e.g., the second electronic device 204) at a time point at which an intent to start the audio service is identified, a start time point of the audio service, a designated time point after the start of the audio service, and/or a designated periodic time point.

The information exchanged between the first electronic device 202 and the second electronic device 204 through the first communication link (e.g., the first communication link 2000 or the first communication link 2400) may include information (e.g., first information and/or second information) related to an operation time point (e.g., a first time and/or a second time) of the audio service. In an embodiment, the information (e.g., the first information and/or the second information) may include at least a part of parameters (e.g., CIS parameters of the control data 600) related to the audio service to be received by the first electronic device 202 and/or the second electronic device 204.

In an embodiment, the information (e.g., the first information and/or the second information) may indicate a time point (e.g., the first time or the second time) at which the first electronic device 202 or the second electronic device 204 receives the audio service with reference to the first communication link (e.g., the first communication link 2000 or the first communication link 2400). For example, when the first communication link is a Bluetooth legacy type, the information may include slot information or clock information indicating a time point at which the first electronic device 202 or the second electronic device 204 receives the audio service. For example, when the first communication link is a BLE type, the information may include time information or clock information indicating a time point at which the first electronic device 202 or the second electronic device 204 receives the audio service. In an embodiment, the information may indicate time periods (e.g., the first time or the second time) in which the first electronic device 202 or the second electronic device 204 can secure the reception of the audio service without interference from other communication operations.

FIG. 32 illustrates time periods of a CIS link according to an embodiment of the disclosure.

Referring to FIG. 32, the electronic device 101 may configure ISO_Interval=20 ms, BN=2, NSE=8, Sub_interval=1.768 ms, FT=4, and Max_PDU=120 bytes for a CIS link (e.g., the first CIS link 2022 for the first electronic device 202). Within the ISO interval 3200 having the 20 ms length, eight subevents according to NSE=8 may be used for a CIS audio service. The eight subevents may include a time period 3202 including two subevents (e.g., R0, L1, R1, and L1) according to BN=2, and a time period 3204 including the remining six subevents.

In an embodiment, the first electronic device 202 may determine that the time period 3202 including two subevents according to BN=2 corresponds to a first time to be secured for the CIS audio service, and transmit first information related to the time period 3202 to the second electronic device 204. Although not shown, the second electronic device 204 may determine the time period 3202 corresponding to two subevents according to BN=2 as the second time to be secured for the CIS audio service, and transmit the second information related to the time period 3202 to the first electronic device 202. In an embodiment, each of the first electronic device 202 and the second electronic device 204 may determine, based on the CIS parameters, the time period 3202 corresponding to two subevents according to BN=2 as the first time and the second time to be secured for the CIS audio service. Both the first electronic device 202 and the second electronic device 204 may commonly determine, based on the CIS parameters, first information for the first time and second information for the second time without communication between each other.

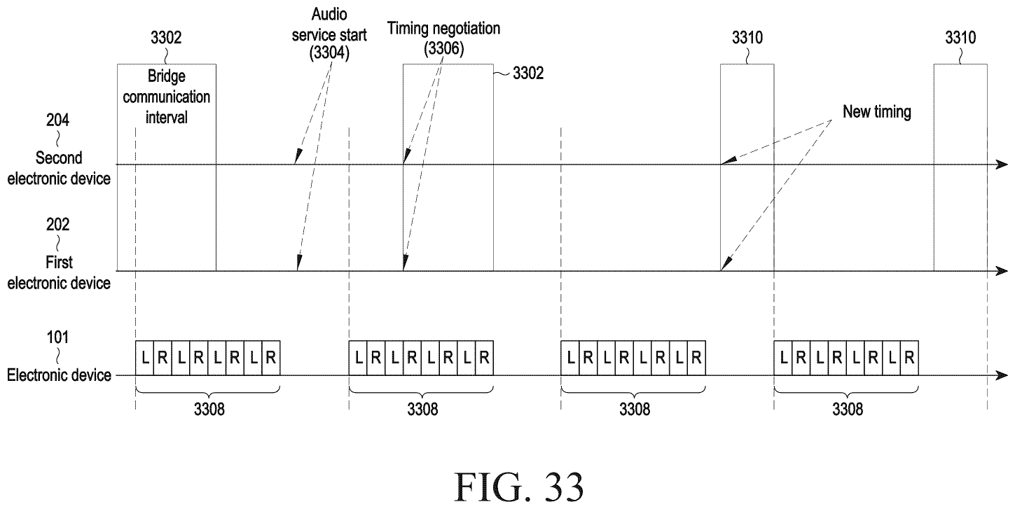

FIG. 33 illustrates an operation of applying a new time in consideration of an audio communication time according to an embodiment of the disclosure.

Referring to FIG. 33, the first electronic device 202 and the second electronic device 204 may determine a time (e.g., time periods 3302) of a first communication link (e.g., the first communication link 2000 or the first communication link 2400) for bridge communication. At time point 3304, the first electronic device 202 and the second electronic device 204 may determine to start to receive an audio service (e.g., a CIS audio service or a BIS audio service) transmitted by the electronic device 101, and connect, based on connection information (e.g., control data 600 or BIG information 1200) of the electronic device 101, with the electronic device 101 (e.g., establish a first CIS link 2022 and second CIS link 2024 or synchronized with a BIG).

At least one of the first electronic device 202 and the second electronic device 204 may determine, based on the connection information, time periods 3308 in which the first electronic device 202 and the second electronic device 204 receive audio data (e.g., L packets and R packets) of the audio service from the electronic device 101.

In an embodiment, the first electronic device 202 may receive, from the second electronic device 204, second information about time periods (e.g., a second time) in which the second electronic device 204 receives audio data (e.g., R packets) of the audio service from the electronic device 101. In an embodiment, the first electronic device 202 may transmit, to the second electronic device 204, first information about time periods (e.g., a first time) in which the first electronic device 202 receives audio data (e.g., L packets) of the audio service from the electronic device 101. In an embodiment, at least one of the first electronic device 202 and the second electronic device 204 may detect that the time periods 3302 of the first communication link at least partially overlap with the time periods 3308 corresponding to an audio time (e.g., a CIS time).

At time point 3306, the first electronic device 202 and the second electronic device 204 may negotiate a new time (e.g., time periods 3310) for a first communication link (e.g., the first communication link 2000 or the first communication link 2400) by using information (e.g., the first information and the second information) shared with each other or connection information (e.g., the control data 600 or the BIG information 1200). The time periods 3310 may be determined within a range in which at least there is no influence on an audio service received by the first electronic device 202 and the second electronic device 204 or the influence is at least minimized. In an embodiment, the time periods 3310 may be determined not to overlap with the time periods 3308 corresponding to the CIS time, or to at least minimally overlap.

In an embodiment, at least one of the first electronic device 202 and the second electronic device 204 may selectively perform at least one of bridge communication or the audio service in time periods in which a time 3302 for bridge communication and a time 3308 for the audio service are duplicate. In an embodiment, when determining that a time is required for bridge communication, for example, when a new time negotiation is required, at least one of the first electronic device 202 and the second electronic device 204 may perform a time negotiation through the first communication link instead of performing the audio service. In an embodiment, at least one of the first electronic device 202 and the second electronic device 204 may stop receiving at least some packets (e.g., “L” packets or “R” packets) of the audio service during designated time periods, and may exchange information (e.g., third information) related to a new time through the first communication link.

In an embodiment, when the first communication link (e.g., the first communication link 2000 or the first communication link 2400) operates using a predetermined window size at each predetermined interval, the first electronic device 202 and/or the second electronic device 204 may adjust at least one of an interval for the first communication link, a window size, or a start time point of a new anchor point to configure new time periods 3310 for the first communication link. In an embodiment, the time periods 3310 may be defined by at least one of the interval, the window size, or the start time point of the new anchor point. In an embodiment, the time periods 3310 may be defined by at least one of a slot interval, a slot count, or a new slot start time point.

The first electronic device 202 and the second electronic device 204 may perform bridge communication in the time periods 3310 so that there is no influence on the audio service or the influence is minimized while receiving audio data (e.g., L packets and R packets) of the audio service from the electronic device 101 in the time periods 3308.

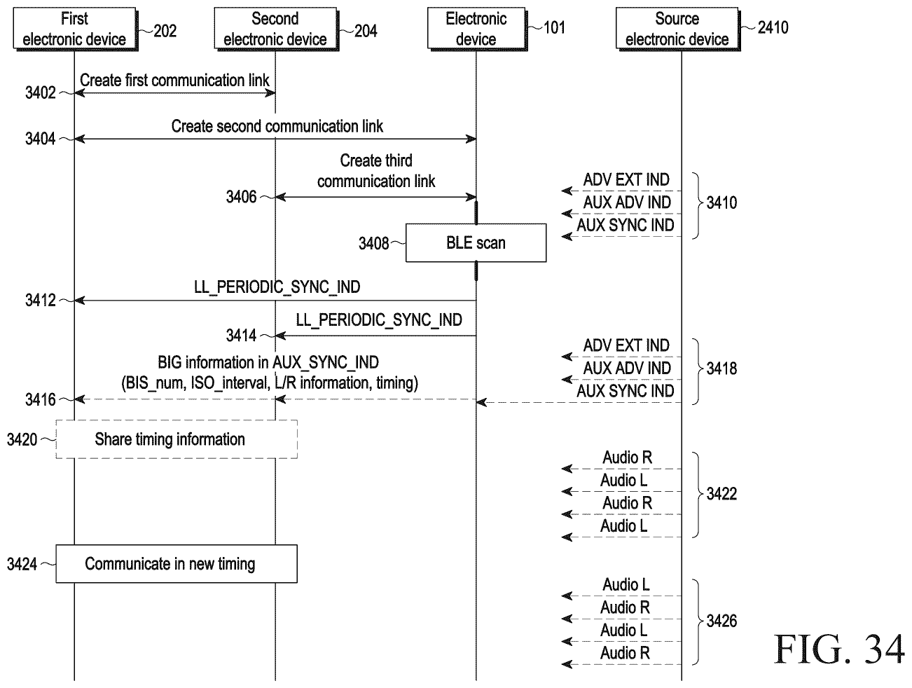

FIG. 34 is a sequence diagram illustrating bridge communication in consideration of a BIS reception time according to an embodiment of the disclosure.

Referring to FIG. 34, in operation 3402, the first electronic device 202 may establish a first communication link (e.g., the first communication link 2400) for bridge communication with the second electronic device 204. In operation 3404, the first electronic device 202 may establish a second communication link (e.g., the second communication link 2512) with the electronic device 101 operating as a BIS assistant role. In operation 3406, the second electronic device 204 may establish a third communication link (e.g., the third communication link 2514) with the electronic device 101.

In operation 3410, the source electronic device 2410 may broadcast periodic advertising data (e.g., an ADV_EXT_IND PDU, an AUX_ADV_IND PDU, and/or an AUX_SYNC_IND PDU) for a BIS audio service. In operation 3408, the electronic device 101 may receive periodic advertising data related to the BIS audio service from the electronic device 2410 through BLE scan. In an embodiment, the electronic device 101 may perform BLE scan to receive the periodic advertising data of the source electronic device 2410 by a designated condition. In an embodiment, the electronic device 101 may perform BLE scan based on reception of a user input through an input means of a user interface of the electronic device 101. For example, the electronic device 101 operating as a BIS assistant role may display a user interface including a BIS device search menu, and may start, based on the reception of the user input through the BIS device search menu, BLE scan to receive the periodic advertising data transmitted by a peripheral source electronic device (e.g., the source electronic device 2410).

In operation 3412, the electronic device 101 may include synchronization information for the BIS audio service in a link layer (LL) message (e.g., an LL_PERIODIC_SYNC_IND PDU) and transmit the same to the first electronic device 202. In operation 3414, the electronic device 101 may include synchronization information for the BIS audio service in an LL message (e.g., an LL_PERIODIC_SYNC_IND PDU) and transmit the same to the second electronic device 204.

In operation 3418, the source electronic device 2410 may broadcast periodic advertising data (e.g., an ADV_EXT_IND PDU, an AUX_ADV_IND PDU, and/or an AUX_SYNC_IND PDU) for the BIS audio service. In operation 3416, at least one of the first electronic device 202 and the second electronic device 204 may obtain, based on the synchronization information, BIG parameters (e.g., BIG information 1200) from the periodic advertising data (e.g., the AUX_SYNC_IND PDU) broadcasted by the source electronic device 2410. In an embodiment, at least one of the first electronic device 202 and the second electronic device 204 may obtain at least one of Num_BIS, ISO_interval, L/R information, or time information within the BIG information 1200.

In an embodiment, the BIG parameters may include an access address (e.g., seed access address), a channel map (e.g., ChM), and BIG parameters (e.g., at least one of Num_BIS, ISO_Interval, BIS_Spacing, Sub_Interval, Max_PDU, Max_SDU, MPT, BN, PTO, IRC, NSE, a framing field, an encrypted field, or the like).

In an embodiment, the first electronic device 202 may calculate, based on the BIG information 1200, a BIS reception time (e.g., at least one of a first time and a second time) in which at least one of the first electronic device 202 and the second electronic device 204 receives audio data for a BIS audio service from the source electronic device 2410. In an embodiment, the second electronic device 204 may calculate, based on the BIG information 1200, a BIS reception time (e.g., at least one of a first time and a second time) in which at least one of the first electronic device 202 and the second electronic device 204 receives audio data for a BIS audio service from the source electronic device 2410.

In operation 3420, the first electronic device 202 and the second electronic device 204 may share information (e.g., first information and second information) on the BIS reception times (e.g., the first time and the second time) with each other.

In an embodiment of the disclosure, the first electronic device 202 and the second electronic device 204 may transmit or receive information on whether an audio service is operated and audio service operation information to or from each other at various time points. In an embodiment, the first electronic device 202 may transmit information (e.g., first information) related to the operation of the audio service in response to an inquiry request from the counterpart electronic device (e.g., the second electronic device 204). In an embodiment, the first electronic device 202 may transmit information (e.g., first information) related to the operation of the audio service to the counter electronic device (e.g., the second electronic device 204), or receive information (e.g., second information) related to the operation of the audio service from the counter electronic device (e.g., the second electronic device 204) at a time point at which an intent to start the audio service is identified, a start time point of the audio service, a designated time point after the start of the audio service, and/or a designated periodic time point.

In an embodiment, the first electronic device 202 and the second electronic device 204 may calculate information (e.g., both the first information and the second information) related to the operation of the audio service of its own and the counter electronic device from the BIG information. The BIG information transmitted by the source electronic device includes both time information of BIS audio data (e.g., left channel audio) which needs to be received by the first electronic device 202 and time information of BIS audio data (e.g., right channel audio) which needs to be received by the second electronic device 204. The first electronic device 202 and the second electronic device 204 may calculate information (e.g., both the first information and the second information) related to the operation of the audio service of its own and the counter electronic device from the BIG information without exchange of the information (e.g., the first information and the second information).

In an embodiment, in operation 3420, the information (e.g., the first information and/or the second information) shared by the first electronic device 202 and the second electronic device 204 may indicate an operation time point of the audio service of each other. In an embodiment, the information (e.g., the first information and/or the second information) may include at least one of the BIG parameters of the audio service received by the first electronic device 202 and/or the second electronic device 204. In an embodiment, the information (e.g., the first information and/or the second information) may indicate a time point (e.g., the first time or the second time) at which the first electronic device 202 or the second electronic device 204 receives the audio service with reference to the first communication link (e.g., the first communication link 2400).

For example, when the first communication link 2400 is a Bluetooth legacy type, the information may include slot information or clock information indicating a time point at which the first electronic device 202 or the second electronic device 204 receives the audio service. For example, when the first communication link 2400 is a BLE type, the information may include time information or clock information indicating a time point at which the first electronic device 202 or the second electronic device 204 receives the audio service. In an embodiment, the information may indicate time periods (e.g., the first time or the second time) in which the first electronic device 202 or the second electronic device 204 can secure the reception of the BIS audio service without interference from other communication operations.

In operation 3424, the first electronic device 202 and the second electronic device 204 may negotiate and re-configure a new time (e.g., the third time or the time periods 3310) for the first communication link (e.g., the first communication link 2400) at a time point at which an intent to start the audio service is identified, a start time point of the audio service, a designated time point after the start of the audio service, and/or a designated periodic time point by using the information (e.g., the first information and the second information) shared to each other or obtained in common. The third time may be determined within a range in which there is no influence on an audio service received by the first electronic device 202 and the second electronic device 204 or the influence is minimized. In an embodiment, the third time may be determined not to overlap with the audio reception times (e.g., the time periods 3308), or to at least minimally overlap.

In operations 3422 and 3426, the source electronic device 2410 may transmit audio data (e.g., L packets and R packets) of the BIS audio service at a designated time (e.g., the first time and the second time). The first electronic device 202 and the second electronic device 204 may be synchronized with the source electronic device 2410 to receive and output the BIS audio data (e.g., L packets and R packets). The first electronic device 202 and the second electronic device 204 may perform bridge communication by using newly configured time periods (e.g., the third time or the time periods 3310) of the first communication link (e.g., the first communication link 2400) while securing reception of the BIS audio service.

FIG. 35 illustrates time periods of a BIG according to an embodiment of the disclosure.

Referring to FIG. 35, the source electronic device 2410 may configure, for a BIG, Num_BIS=2, ISO_Interval=20 ms, BN=2, NSE=10, Sub_Interval=1.188 ms, BIS_spacing=594 μs, PTO=1, IRC=3, and Max_PDU=100 bytes. Within the ISO interval 3500 having the 20 ms length, five subevent groups according to NSE=10 and BN=2 may be used for a BIS audio service. The five subevent groups may include a time period 3502 including three subevent groups (e.g., R0, L1, R1, L1, R0, L1, R1, L1, R0, L1, R1, and L1) according to IRC=3, and a time period 3504 including two subevent groups (e.g., R2, L2, R3, L3, R4, L4, R5, and L5) for future BIS audio data.

In an embodiment, the first electronic device 202 may determine the time period 3502 including three subevent groups according to IRC=3 as the first time and the second time which need to be secured for the BIS audio service. Similarly, in an embodiment, the second electronic device 204 may determine the time period 3502 as the first time and the second time which need to be secured for the BIS audio service.

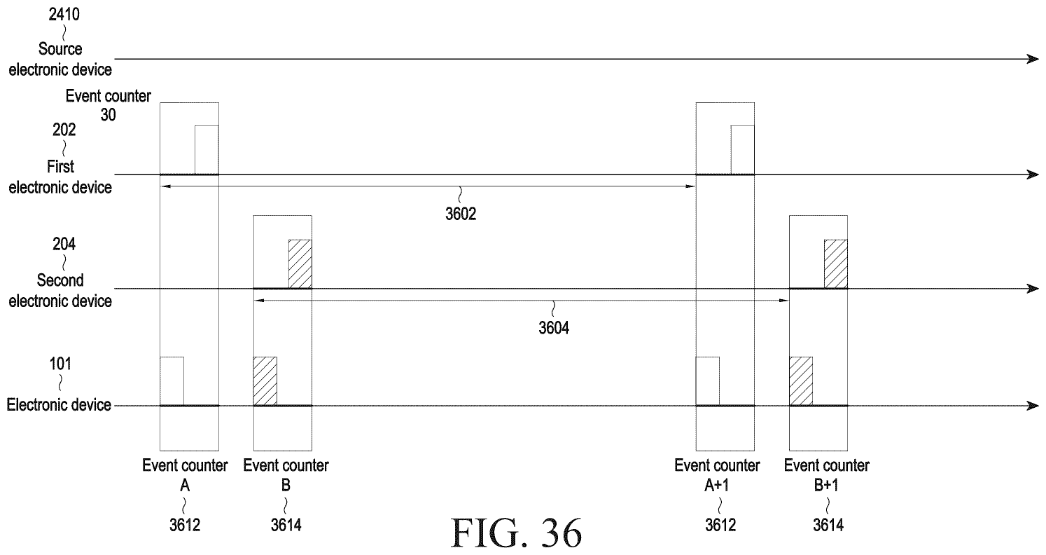

FIG. 36 illustrates an example of changing operation information of a second communication link and a third communication link according to an embodiment of the disclosure.

Referring to FIG. 36, an electronic device (e.g., the electronic device 101) operating as a BIS assistant role may change, based on at least one of a request from the first electronic device 202, a request from the second electronic device 204, or a determination by the electronic device 101, operation information related to operation of at least one link between a second communication link (e.g., the second communication link 2512) between the electronic device 101 and the first electronic device 202 and a third communication link (e.g., the third communication link 2514) between the electronic device 101 and the second electronic device 204. In an embodiment, the operation information may include at least one of an interval, an event length, or an anchor point.

In an embodiment, event counter A of the second communication link 2512 (e.g., a first ACL link) related to the first electronic device 202 may start from each connection interval 3602. The electronic device 101 may exchange packets with the first electronic device 202 during designated time periods 3612 for the second communication link 2512 within each connection interval 3602. In an embodiment, event counter B of the third communication link 2514 (e.g., a second ACL link) related to the second electronic device 204 may start at each connection interval 3604. The electronic device 101 may exchange packets with the second electronic device 204 during designated time periods 3614 for the third communication link 2514 within each connection interval 3604.

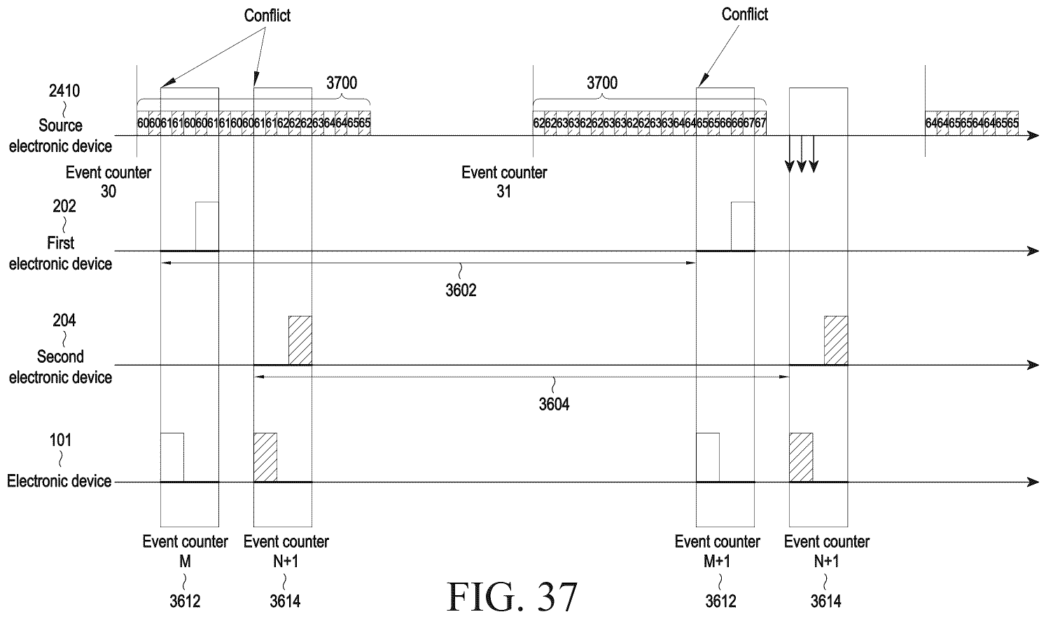

FIG. 37 illustrates a conflict between BIS audio and a second communication link and a third communication link according to an embodiment of the disclosure.

Referring to FIG. 37, the first electronic device 202 may be synchronized, based on synchronization information received from the electronic device 101, with a BIG (e.g., at least one BIS) of the source electronic device 2410 through a second communication link 2512 (e.g., during time periods 3612). In an embodiment, the first electronic device 202 may be synchronized, based on synchronization information received from the electronic device 101, with a BIG of the source electronic device 2410 through a third communication link 2514 (e.g., during time periods 3614). A reception time (e.g., time periods 3700) in which the first electronic device 202 or the second electronic device 204 receives a BIS synchronization service may be repeated at each designated time period (e.g., an ISO interval included in the BIG information 1200).

At least one of the first electronic device 202, the second electronic device 204, or the electronic device 101 may detect, by a designated criterion, a conflict between the time periods 3700 in which the BIS audio service is received and at least one of the second communication link 2512 and the third communication link 2514.

In an embodiment, the first electronic device 202 or the second electronic device 204 may determine that the time periods 3700 for the synchronized BIS audio service at least partially overlap with a communication time (e.g., the time periods 3612 or the time periods 3614) of the second communication link 2512 or the third communication link 2514, and may request the electronic device 101 to change the communication time (e.g., the time periods 3612 or the time periods 3614) of the second communication link 2512 or the third communication link 2514.

In an embodiment, the electronic device 101 may determine that the time periods 3700 for the BIS audio service at least partially overlap with the time periods 3612 of the second communication link 2512 or the time periods 3614 of the third communication link 2514, and determine to change the communication time (e.g., the time periods 3612 or the time periods 3614) of the second communication link 2512 or the third communication link 2514.

In an embodiment, the electronic device 101 may determine, based on the BIS information 1200, reception times (e.g., the time periods 3700) of the BIS audio service related to the first electronic device 202 or the second electronic device 204 before or after transmitting synchronization information related to the BIG information (e.g., the BIG information 1200) to the first electronic device 202 or the second electronic device 204 through the second communication link 2512 or the third communication link 2514. The electronic device 101 may change, based on the time periods 3700 conflicting with (e.g., at least partially overlapping with) the time periods 3612 or the time periods 3614, operation information (e.g., ACL parameters) of the second communication link 2512 or the third communication link 2514.

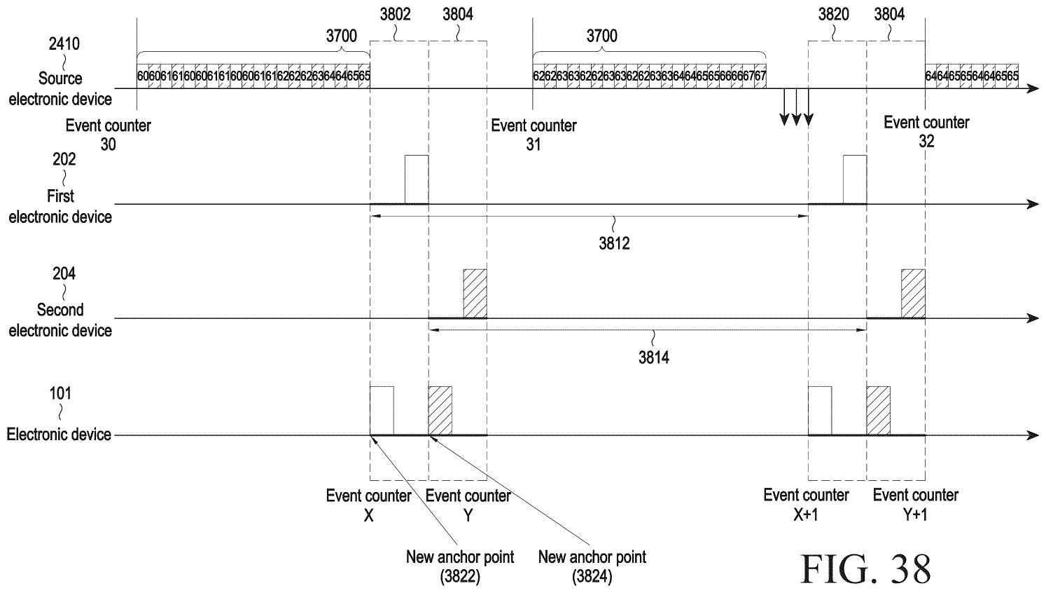

FIG. 38 illustrates an example of avoiding a conflict with BIS audio according to an embodiment of the disclosure.

Referring to FIG. 38, the electronic device 101 may determine, based on the BIG information 1200, reception times (e.g., time periods 3700) of the BIS audio service related to the first electronic device 202 or the second electronic device 204 before or after transmitting synchronization information related to the BIG information (e.g., the BIG information 1200) to the first electronic device 202 or the second electronic device 204 through the second communication link 2512 or the third communication link 2514. The electronic device 101 may determine a new communication time (e.g., time periods 3802 and 3804) of the second communication link 2512 and/or the third communication link 2514 so that the new communication time does not overlap with the time periods or overlaps with the time periods 3700 at least minimally. In an embodiment, the time periods 3802 and 3804 may be changed as operation information (e.g., ACL parameters) of the second communication link 2512 and/or the third communication link 2514 is re-configured.

In an embodiment, the electronic device 101 may determine operation information (e.g., a connection interval between a first ACL link and a second ACL link, an event length, or an anchor point) of the second communication link 2512 and the third communication link 2514 so that the new time periods 3802 and 3804 of the second communication link 2512 and the third communication link 2514 do not overlap with the time periods 3700 of the BIS audio service or overlap with the time periods at least minimally.

The electronic device 101 may provide the determined operation information to the first electronic device 202 and/or the second electronic device 204. In an embodiment, the electronic device 101 may provide ACL parameters (e.g., at least one of a connection interval 3812, an event length, or an anchor point 3822 of a first ACL link) specifying a new communication time (e.g., time periods 3802) of the second communication link 212 to the first electronic device 202 through the second communication link 2512. The first electronic device 202 may communicate with the electronic device 101 by using the time periods 3802 from event counter X of the second communication link 2512. In an embodiment, the electronic device 101 may provide ACL parameters (e.g., at least one of a connection interval 3814, an event length, or an anchor point 3824 of a second ACL link) specifying a new communication time (e.g., the time periods 3804) of the third communication link 2514 to the second electronic device 204 through the third communication link 2514. The second electronic device 204 may communicate with the electronic device 101 by using the time periods 3804 from event counter Y of the third communication link 2514.

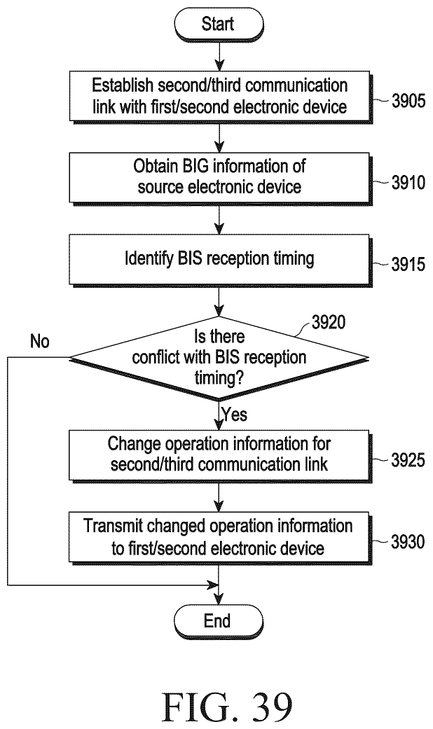

FIG. 39 is a flowchart illustrating a procedure of changing a communication time in consideration of a BIS audio service according to an embodiment of the disclosure.

According to embodiments, at least one of the operations to be described below may be omitted or changed, or the sequence thereof may be changed. According to an embodiment, at least one of the operations to be described below may be executed by the electronic device 101 (e.g., the processor 120).

Referring to FIG. 39, in operation 3905, an electronic device 101 (e.g., the processor 120) may create (e.g., establish) a second communication link 2512 and/or a third commination link 2514 with a first electronic device 202 and/or a second electronic device 204, respectively. In an embodiment, the electronic device (e.g., the processor 120) may identify a communication time (e.g., the time periods 3612) between the electronic device 101 and the first electronic device 202 in the second communication link 2512. In an embodiment, the electronic device 101 (e.g., the processor 120) may identify a communication time (e.g., the time periods 3614) between the electronic device 101 and the second electronic device 204 in the third communication link 2514.

In operation 3910, the electronic device 101 (e.g., the processor 120) may obtain BIG parameters (e.g., BIG information 1200) for a BIS audio service of the source electronic device 2410. In an embodiment, the electronic device 101 (e.g., the processor 120) may discover the source electronic device 2410 through BLE scan and receive the BIG parameters through a periodic advertising packet broadcasted from the source electronic device 2410. In an embodiment, the BIG parameters may be used for the electronic device 101 to determine a conflict between the BIS audio reception time of the first electronic device 202 and/or the second electronic device 204 and the second communication link 2512 and/or the third communication link 2514, and change operation information of the second communication link 2512 and/or the third communication link 2514.

In operation 3915, the electronic device 101 (e.g., the processor 120) may calculate, based on the BIG parameters, a BIS reception time (e.g., the time periods 3700) for receiving BIS audio data. In an embodiment, the electronic device 101 (e.g., the processor 120) may calculate, based on the BIG parameters, a first time in which the electronic device 202 receives BIS audio data (e.g., “L” packets). In an embodiment, the electronic device (e.g., the processor 120) may calculate, based on the BIG parameters, a second time in which the second electronic device 204 receives BIS audio data (e.g., “R” packets).

In operation 3920, the electronic device 101 (e.g., the processor 120) may determine whether the BIS reception time conflicts with the communication time (e.g., the time periods 3612 and the time periods 3614) of the second communication link 2512 and/or the third communication link 2514 for communication with the first electronic device 202 and/or the second electronic device 204.

When the BIS reception time does not conflict or does not at least partially overlap with the communication time of the second communication link 2512 and/or the third communication link 2514, the electronic device 101 (e.g., the processor 120) may end the operation and the communication time (e.g., the time periods 3612 and the time periods 3614) of the second communication link 2512 and/or the third communication link 2514 may be maintained. On the other hand, when the BIS reception time conflicts with or at least partially overlaps with the communication time of the second communication link 2512 and/or the third communication link 2514, the electronic device 101 (e.g., the processor 120) may proceed to operation 3925.

In operation 3925, the electronic device 101 (e.g., the processor 120) may calculate, based on the BIS reception time (e.g., the time periods 3700), an idle time period not overlapping with the BIS reception time, and change, based on the idle time period, operation information (e.g., ACL parameters) for the second communication link 2512 and/or the third communication link 2514. In an embodiment, the electronic device 101 (e.g., the processor 120) may determine the ACL parameters so that a new communication time (e.g., the time periods 3802 and/or the time periods 3804) for the second communication link 2512 and/or the third communication link 2514 does not overlap with or at least minimally overlaps with the BIS reception time.

In operation 3930, the electronic device 101 (e.g., the processor 120) may transmit the operation information (e.g., ACL parameters including at least one of the connection intervals 3812 and 3814, the event lengths, or the anchor points 3822 and 3824) calculated for the second communication link 2512 and/or the third communication link 2514 to the first electronic device 202 and/or the second electronic device 204 through the second communication link 2512 and/or the third communication link 2514. While the first electronic device 202 and/or the second electronic device 204 receives the BIS audio service, the electronic device 101 (e.g., the processor 120) may communicate with the first electronic device 202 and/or the second electronic device 204 through the second communication link 2512 and/or the third communication link 2514 without interference with the BIS audio service of the first electronic device 202 and/or the second electronic device 204.

An electronic device 202 according to an embodiment may include a communication circuit 320, memory 390 configured to store instructions, and at least one processor 310 functionally connected to the communication circuit and the memory. The instructions, when executed by the at least one processor, may cause the first electronic device to establish a communication link (2000 or 2400) with a second electronic device (204) through the communication circuit. The instructions, when executed by the at least one processor, may cause the first electronic device to determine first information related to a first time (1802, 1804, or 1806) in which the first electronic device receives first audio data of an audio service from a source electronic device (101 or 2410). The instructions, when executed by the at least one processor, may cause the first electronic device to acquire second information related to a second time (1812, 1814, or 1816) in which the second electronic device receives second audio data of the audio service from the source electronic device. The instructions, when executed by the at least one processor, may cause the first electronic device to determine, based on the first time and the second time, a third time (1822 or 1824) for the communication link. The instructions, when executed by the at least one processor, may cause the first electronic device to communicate with the second electronic device through the communication link by using the third time.

In an embodiment, the instructions may cause the first electronic device to receive the second information related to the second time from the second electronic device through the communication circuit.

In an embodiment, the second information may include at least one of slot information, time information, or clock information indicating the second time.

In an embodiment, the instructions may cause the first electronic device to transmit the first information to the second electronic device through the communication circuit.

In an embodiment, the instructions may cause the first electronic device to calculate, based on parameters received from the source electronic device, the second time.

In an embodiment, the instructions may cause the first electronic device to calculate an idle time period in which the first time and the second time do not overlap, and calculate, based on the idle time period, at least one of a time interval and a start time point of the third time for allocation to the communication link.

In an embodiment, the instructions may cause the first electronic device to determine the third time by at least one of an interval, a window size, or a start time point of an anchor point.

In an embodiment, the instructions may cause the first electronic device to determine the third time by at least one of a slot interval, the number of slots, or a slot start time point.

In an embodiment, at least one of the first time or the second time may include a time period corresponding to one or more subevents defined by a burst number (BN) number parameter among connected isochronous stream (CIS) parameters received from the source electronic device.

In an embodiment, at least one of the first time or the second time may include a time period corresponding to one or more subevent groups defined by an immediate repetition count (IRC) parameter among broadcast isochronous stream (BIS) parameters received from the source electronic device.

An electronic device 101 according to an embodiment may include memory 130 configured to store instructions, a wireless communication module 192, and at least one processor 120 functionally connected to the memory and the wireless communication module. The instruction, when executed by the at least one processor, may cause the electronic device to establish at least one communication link (2512 or 2514) with at least one external electronic device (202 or 204) through the wireless communication module. The instructions, when executed by the at least one processor, may cause the electronic device to determine a first time (3700) in which the at least one external electronic device receives an audio service from a source electronic device (2410). The instructions, when executed by the at least one processor, may cause the electronic device to determine whether the first time conflicts with a second time (3612 or 3614) in which the electronic device and the at least one external electronic device communicate. The instructions, when executed by the at least one processor, may cause the electronic device to, in case that the first time conflicts with the second time, determine operating information indicating a third time configured for the at least one communication link so as not to overlap at least partially with the first time. The instructions, when executed by the at least one processor, may cause the electronic device to transmit the operating information to the at least one external electronic device through the wireless communication module.

The instructions may cause the electronic device to change at least one parameter among a connection interval for the communication link, an event length, or an anchor point, and generate the operation information including the changed parameter.

An operation method of a first electronic device 202 according to an embodiment may include establishing (1905) a communication link (2000 or 2400) with a second electronic device (204). The method may include determining (1915) first information related to a first time (1802, 1804, or 1806) in which the first electronic device receives first audio data of an audio service from a source electronic device (101 or 2410). The method may include acquiring (1920) second information related to a second time (1812, 1814, or 1816) in which the second electronic device receives second audio data of the audio service from the source electronic device. The method may include determining (1925), based on the first time and the second time, a third time (1822 or 1824) for the communication link. The method may include communicating (1930) with the second electronic device through the communication link by using the third time.

In an embodiment, the acquiring of the second information may include receiving the second information from the second electronic device.

In an embodiment, the second information may include at least one of slot information, time information, or clock information indicating the second time.

In an embodiment, the method may further include transmitting the first information to the second electronic device.

In an embodiment, the acquiring of the second information may include calculating, based on parameters received from the source electronic device, the second time.

In an embodiment, the determining of the third time may include calculating an idle time period in which the first time and the second time do not overlap, and calculating, based on the idle time period, at least one of a time interval and a start time point of the third time for allocation to the communication link.

In an embodiment, the third time may be defined by at least one of an interval, a window size, or a start time point of an anchor point.

In an embodiment, the third time may be defined by at least one of a slot interval, the number of slots, or a slot start time point.

In an embodiment, at least one of the first time or the second time may include a time period corresponding to one or more subevents defined by a burst number (BN) number parameter among connected isochronous stream (CIS) parameters received from the source electronic device.

In an embodiment, at least one of the first time or the second time may include a time period corresponding to one or more subevent groups defined by an immediate repetition count (IRC) parameter among broadcast isochronous stream (BIS) parameters received from the source electronic device.

An operation method of an electronic device 101 according to an embodiment may include establishing (3905) at least one communication link (2512 or 2514) with at least one external electronic device (202 or 204). The method may include determining (3910 or 3915) a first time (3700) in which the at least one external electronic device receives an audio service from a source electronic device (2410). The method may include determining (3820) whether the first time conflicts with a second time (3612 or 3614) in which the electronic device communicates with the at least one external electronic device. The method may include in case that the first time conflicts with the second time, determining (3925) operating information indicating a third time configured for the at least one communication link so as not to overlap at least partially with the first time. The method may include transmitting (3930) the operating information to the at least one external electronic device.

In an embodiment, the determining of the operation information may include changing at least one parameter among a connection interval for the communication link, an event length, or an anchor point, and generating the operation information including the changed parameter.

One or more non-transitory computer-readable storage media storing one or more computer programs may include computer-executable instructions that, when executed by one or more processors of an electronic device individually or collectively, cause the electronic device to perform operations, the operations comprising establishing a communication link with a second electronic device, determining first information related to a first time in which a first electronic device receives first audio data of an audio service from a source electronic device, acquiring second information related to a second time in which the second electronic device receives second audio data of the audio service from the source electronic device, based on the first time and the second time, determining a third time for the communication link, and communicating with the second electronic device through the communication link by using the third time.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., memory 390, internal memory 136 or external memory 138) that is readable by a machine (e.g., the electronic device 202 or 204 or the electronic device 101). For example, a processor (e.g., the processor 310 or the processor 120) of the machine (e.g., the electronic device 202 or 204 or the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A first electronic device comprising:
communication circuitry;
memory storing instructions; and
at least one processor communicatively coupled to the communication circuitry and the memory,
wherein the instructions, when executed by the at least one processor individually or collectively, cause the first electronic device to:
establish a communication link with a second electronic device through the communication circuitry,
determine first information related to a first time in which the first electronic device receives first audio data of an audio service from a source electronic device,
acquire second information related to a second time in which the second electronic device receives second audio data of the audio service from the source electronic device,
based on the first time and the second time, determine a third time (for the communication link, and
communicate with the second electronic device through the communication link by using the third time.

2. The first electronic device of claim 1,
wherein the instructions, when executed by the at least one processor individually or collectively, further cause the first electronic device to receive the second information related to the second time from the second electronic device through the communication circuitry, and
wherein the second information comprises at least one of slot information, time information, or clock information indicating the second time.

3. The first electronic device of claim 2, wherein the instructions, when executed by the at least one processor individually or collectively, further cause the first electronic device to transmit the first information to the second electronic device through the communication circuitry.

4. The first electronic device of claim 1, wherein the instructions, when executed by the at least one processor individually or collectively, further cause the first electronic device to calculate the second time, based on parameters received from the source electronic device.

5. The first electronic device of claim 1, wherein the instructions, when executed by the at least one processor individually or collectively, further cause the first electronic device to:
calculate an idle time period in which the first time and the second time do not overlap; and
based on the idle time period, calculate at least one of a time interval and a start time point of the third time for allocation to the communication link.

6. The first electronic device of claim 1, wherein the instructions, when executed by the at least one processor individually or collectively, further cause the first electronic device to:
determine the third time by at least one of an interval, a window size, or a start time point of an anchor point; or
determine the third time by at least one of a slot interval, a number of slots, or a slot start time point.

7. The first electronic device of claim 1, wherein at least one of the first time or the second time comprises a time period corresponding to one or more subevents defined by a burst number (BN) number parameter among connected isochronous stream (CIS) parameters received from the source electronic device.

8. The first electronic device of claim 1, wherein at least one of the first time or the second time comprises a time period corresponding to one or more subevent groups defined by an immediate repetition count (IRC) parameter among broadcast isochronous stream (BIS) parameters received from the source electronic device.

9. An electronic device comprising:
memory storing instructions;
a wireless communication module; and
at least one processor communicatively coupled to the memory and the wireless communication module,
wherein the instructions, when executed by the at least one processor individually or collectively, cause the electronic device to:
establish at least one communication link with at least one external electronic device through the wireless communication module,
determine a first time in which the at least one external electronic device receives an audio service from a source electronic device,
determine whether the first time conflicts with a second time in which the electronic device communicates with the at least one external electronic device,
in case that the first time conflicts with the second time, determine operating information indicating a third time configured for the communication link so as not to overlap at least partially with the first time, and
transmit the operating information to the at least one external electronic device through the wireless communication module.

10. The electronic device of claim 9, wherein the instructions, when executed by the at least one processor individually or collectively, further cause the electronic device to:
change at least one parameter among an event length, an anchor point, or a connection interval for the communication link; and
generate the operating information comprising the changed parameter.

11. A method of operating a first electronic device, the method comprising:
establishing a communication link with a second electronic device;
determining first information related to a first time in which the first electronic device receives first audio data of an audio service from a source electronic device;
acquiring second information related to a second time in which the second electronic device receives second audio data of the audio service from the source electronic device;
based on the first time and the second time, determining a third time for the communication link; and
communicating with the second electronic device through the communication link by using the third time.

12. The method of claim 11,
wherein the acquiring of the second information comprises:
receiving the second information related to the second time from the second electronic device, or
based on parameters received from the source electronic device, calculating the second time,
wherein the second information comprises at least one of slot information, time information, or clock information indicating the second time, and
wherein the first information is transmitted to the second electronic device.

13. The method of claim 12, further comprising:
transmitting the first information to the second electronic device.

14. The method of claim 11, wherein the acquiring second information comprises calculating the second time, based on parameters received from the source electronic device.

15. The method of claim 11,
wherein the determining of the third time comprises:
calculating an idle time period in which the first time and the second time do not overlap, and
based on the idle time period, calculating at least one of a time interval and a start time point of the third time for allocation to the communication link.

16. The method of claim 11, wherein the third time is defined by at least one of an interval, a window size, or a start time point of an anchor point, or
wherein the third time is defined by at least one of a slot interval, a number of slots, or a slot start time point.

17. The method of claim 11,
wherein at least one of the first time or the second time comprises a time period corresponding to one or more subevents defined by a burst number (BN) number parameter among connected isochronous stream (CIS) parameters received from the source electronic device.

18. The method of claim 11, wherein at least one of the first time or the second time comprises a time period corresponding to one or more subevent groups defined by an immediate repetition count (IRC) parameter among broadcast isochronous stream (BIS) parameters received from the source electronic device.

19. A method of operating an electronic device, the method comprising:
establishing at least one communication link with at least one external electronic device;
determining a first time in which the at least one external electronic device receives an audio service from a source electronic device;
determining whether the first time conflicts with a second time (in which the electronic device communicates with the at least one external electronic device;
in case that the first time conflicts with the second time, determining operating information indicating a third time configured for the at least one communication link so as not to overlap at least partially with the first time; and
transmitting the operating information to the at least one external electronic device.

20. The method of claim 19, wherein the determining operating information comprises:
changing at least one parameter among an event length, an anchor point, or a connection interval for the communication link; and
generating the operating information comprising the changed parameter.
